(19) United States
(12) Patent Application Publication
(10) Pub. No.: US 2026/0103385 A1
(43) Pub. Date: Apr. 16, 2026

(54) PROCESS FOR PRODUCING A MATERIAL COMPRISING GRAPHENE AND/OR GRAPHITE ON A MATRIX, AND MATERIALS PREPARED THEREFROM

(71) Applicant: BIO GRAPHENE SOLUTIONS INC., Toronto (CA)

(72) Inventors: Gary VAN DUSEN, Cambridge (CA); Rafaella OLIVEIRA DO NASCIMENTO, Houston, TX (US)

(21) Appl. No.: 19/103,237

(22) PCT Filed: Aug. 11, 2023
(86) PCT No.: PCT/CA2023/051070

§ 371 Date: Feb. 12, 2025

Related U.S. Application Data
(60) Provisional application No. 63/371,248, filed on Aug. 12, 2022.

(51) Int. Cl. C01B 32/205; C01B 32/184

(52) U.S. Cl. CPC C01B 32/205; C01B 32/184; C01B 2204/32; C01P 2002/82; C01P 2002/85; C01P 2004/02; C01P 2004/03; C01P 2004/04

(57) ABSTRACT

The present document relates to a process for the preparation of a material containing graphene grown in situ on a matrix from a carbon source, the process comprising at least one thermal treatment carried at a temperature of at least 550° C., for instance between 550° C. and 1400° C., wherein the process does not include injection of external hydrogen or an inert gas.

### RELATED APPLICATION

The present application claims priority under applicable law to U.S. provisional application No. 63/371,248 filed on Aug. 12, 2022, the content of which is incorporated herein by reference in its entirety and for all purposes.

### TECHNICAL FIELD

This technology generally relates to methods of growing and producing graphene and/or graphite on a substrate or matrix, for instance, from carbon-containing materials (such as carbohydrate, for instance from biomass, organic or petroleum based oils, wax, alcohols, resins, gums, etc.), to the graphene and/or graphite and to the materials containing graphene and/or graphite produced therefrom and to uses thereof.

### BACKGROUND

Graphene is one of the allotropes of carbon, which was initially defined as a single layer of graphite and was obtained by its mechanical exfoliation. Graphene currently rather refers to a class of nanomaterials that includes nanoplatelets, few-layer graphene, single-layer graphene, graphene oxide, reduced graphene oxide, etc.

Many techniques have been developed for the synthesis of graphene, including chemical vapor deposition (CVD), thermal plasma, flash graphene growth, graphene exfoliation, electrochemical exfoliation, micromechanical exfoliation, flash graphene growth, pyrolysis, etc. These techniques may accommodate different source of carbon and may or may not require metals as catalyst. Techniques such as CVD, thermal plasma, and flash graphene growth produce highly crystalline graphene with a single or few layers. However, each of these techniques require a controlled atmosphere and high purity gases including hydrogen, or high voltage discharge that need highly controlled conditions.

Synthetic methods for preparing graphene that use bio-products such as nut shells and carbohydrates generally require further chemical treatments. Additionally, other methods need a chemical pre-treatment of the carbon source, and/or post-treatment of the obtained graphene-like material. The resulting products then resemble graphene/graphite-like materials or a mix of graphene oxide, graphene/graphite platelets and surface functionalized graphene, graphene platelets, graphite, and/or synthetic graphite.

Synthetic graphite is conventionally defined as a material consisting of graphitic carbon which has been obtained by graphitizing of non-graphitic carbon, by techniques such as chemical vapor deposition (CVD) from hydrocarbons at temperatures above 2000° C., by decomposition of thermally unstable carbides or by crystallizing from metal melts supersaturated with carbon. Additionally, synthetic graphite is also named artificial graphite. Synthetic graphite is also obtained by the pyrolysis of natural gas (methane, CH₄) in the presence of metals such as iron. This method is known as the Hazer (Hydrogen And Zero Emissions Research) process that also produces hydrogen as a byproduct.

Graphene is now used in multiple applications, including for instance, as additives in concrete, asphalt, composites, anti-corrosion coatings and paints, 3D printing, electrodes, solar panels, flexible panels, thermal foils, sensors, and many more. In most of these applications, the graphene is combined with other materials and dispersion of the graphene within the material may be inhomogeneous. Additionally, graphene and its products are used into quantum computing, heteronanostructures, new generation of metal-organic framework (MOF) and covalent organic framework (COF), water and gas filtration systems, optical sensors, smart glass, stray light reducing black coatings, etc. Stray light reducing black coatings are also known as fractal black coatings or simply black coatings and possess high light absorption capacity. The purpose of black coating in optics is generally to prevent or reduce light from getting in an image plane, as well as to reduce stray light in the chamber and optical pieces.

There thus remains a need for the development of alternative processes for producing materials containing graphene under conditions applicable to an industrial scale and avoiding one or more of the disadvantages present in other processes.

### SUMMARY

According to one aspect, the present technology relates to a process for producing a material comprising graphene and/or graphite from a carbon-containing material, where the graphene or graphite is grown and/or produced on a matrix, including within the porosity of the matrix, on the surface of the matrix, and/or between matrix particles, as well as to the graphene and materials containing graphene which are produced therefrom and their uses. More specifically, the following embodiments are provided:

Embodiment 1. Process for the preparation of a material comprising graphene and/or graphite on a matrix, said process comprising the steps of:
contacting a carbon-containing material, and optionally a catalyst, with a matrix; and
thermally treating at a temperature above 550° C. to induce graphitization and produce a graphitized carbon;
wherein said process excludes injection of hydrogen or inert gas and in the presence of restricted air; and
wherein said matrix is a material that does not react or decompose when exposed to the thermal treatment conditions.

Embodiment 2. The process of embodiment 1, wherein said contacting step comprises spraying, soaking, mixing, the carbon-containing material on or with the matrix, wherein the carbon-containing material is optionally melted or dissolved to form a solution prior to spraying, soaking or mixing.

Embodiment 3. The process of embodiment 1 or 2, wherein said carbon-containing material is selected from carbohydrate sources, for instance from biomass, organic or petroleum-based oils, waxes, alcohols, resins, gums, or a combination of two or more thereof.

Embodiment 4. The process of embodiment 1, said process comprising the steps of:
(a) preparing a solution containing a carbohydrate source, and optionally a catalyst, in a solvent (such as an aqueous solvent, e.g. water);
(b) contacting the solution from (a) with a matrix to obtain a mixture or coating on the matrix;
(c) optionally drying the mixture or coating at a temperature of at least 100° C.; and
(d) thermally treating at a temperature above 550° C. to induce graphitization and produce a graphitized carbon;
wherein said process excludes injection of hydrogen or inert gas and in the presence of restricted air; and
wherein said matrix is a material that does not react or decompose when exposed to the conditions of the process.

Embodiment 5. The process of embodiment 4, wherein said carbohydrate source comprises a monosaccharide, disaccharide, oligosaccharide or polysaccharide, or a mixture of two or more thereof.

Embodiment 6. The process of embodiment 4 or 5, wherein said carbohydrate source comprises a monosaccharide or disaccharide, or a mixture thereof.

Embodiment 7. The process of any one of embodiments 4 to 6, wherein said carbohydrate source comprises an oligosaccharide or polysaccharide, or a mixture thereof.

Embodiment 8. The process of any one of embodiments 4 to 7, wherein said carbohydrate source is fruit peels and processing refuse (e.g. orange peel, pulp, etc.), cereal husks (e.g. rice husks), wood waste, bagasse, wastepaper, recycled cotton fabric, biochar, nut shells, and the like.

Embodiment 9. The process of any one of embodiments 4 to 8, wherein said contacting step of step (b) comprises mixing, soaking or spraying the matrix with the solution.

Embodiment 10. The process of any one or embodiments 4 to 9, wherein said step (c) is present and carried out at a temperature within the range of about 150° C. to about 300° C., preferably about 200° C. to about 300° C., more preferably about 200° C. to about 250° C.

Embodiment 11. The process of any one or embodiments 4 to 10, wherein said step (c) further comprises breaking di-, oligo- and/or polysaccharide chains from the carbohydrate source.

Embodiment 12. The process of any one of embodiments 1 to 11, wherein said matrix comprises at least one of sand, quartz, silica, gravel, granite, basalt, cement, concrete, asphalt, calcium carbonate, glass (e.g. powder, beads, fibers, etc.), metal and metal alloy surfaces (e.g. rods, grids, fibers, rebar, etc.), metal and metal alloy powders (e.g. nanoparticles, microparticles, etc.), metal oxides (e.g. TiO₂, Al₂O₃, etc.), ceramics such as zeolites (e.g. sodium aluminosilicate zeolites), inorganic dyes, nanomaterials, boron nitrate (e.g. nanotubes or nanosheets), metal chalcogenides (e.g. transition metal dichalcogenides (TMDC)), or a combination of at least two thereof.

Embodiment 13. The process of any one of embodiments 1 to 12, wherein step (a) or the contacting step comprises the catalyst.

Embodiment 14. The process of embodiment 13, wherein said catalyst is selected from FeCl₃, metal or metal alloys (e.g. Cu, Ge, Ni) particles or powders, metal oxides, or a combination thereof.

Embodiment 15. The process of any one of embodiments 1 to 14, wherein said thermal treatment step is carried out at a temperature within the range of about 550° C. to about 1400° C.

Embodiment 16. The process of embodiment 15, wherein said thermal treatment step is carried out at a temperature within the range of about 700° C. to about 1200° C.

Embodiment 17. The process of embodiment 15, wherein said thermal treatment step is carried out at a temperature within the range of about 800° C. to about 1100° C.

Embodiment 18. The process of embodiment 15, wherein said thermal treatment step is carried out at a temperature within the range of about 550° C. to about 1000° C., or about 550° C. to about 900° C.

Embodiment 19. The process of any one of embodiments 1 to 18, wherein said thermal treatment step is carried out in a covered vessel (e.g. including a lid) wherein said covered vessel is not sealed or wherein said covered vessel is sealed and includes pressure release valves or pressure control means, preferably the covered vessel is not sealed.

Embodiment 20. The process of any one of embodiments 1 to 19, wherein said thermal treatment step comprises in situ generation of hydrogen (H₂).

Embodiment 21. The process of any one of embodiments 1 to 20, wherein said process further comprises an intermediate thermal treatment carried out at a temperature within the range of about 400° C. to about 700° C. before step (d).

Embodiment 22. The process of embodiment 21, wherein said intermediate thermal treatment is carried out at a temperature within the range of about 500° C. to about 650° C.

Embodiment 23. The process of embodiment 21, wherein said intermediate thermal treatment is carried out at a temperature within the range of about 500° C. to about 600° C.

Embodiment 24. The process of any one of embodiments 1 to 23, wherein said process further comprises a step (e) after step (d), said step (e) comprising thermally treating the material of step (d) at a temperature within the range of about 200° C. to about 600° C. in the presence of air to eliminate residual amorphous carbon.

Embodiment 25. The process of embodiment 24, wherein said thermal treatment of step (e) is carried out at a temperature within the range of about 200° C. to about 350° C.

Embodiment 26. The process of any one of embodiments 1 to 25, wherein said process further comprises a mechanical treatment (e.g. grinding, milling, etc.) after step (d).

Embodiment 27. The process of embodiment 24 or 25, wherein said process further comprises a mechanical treatment (e.g. grinding, milling, etc.) after step (e).

Embodiment 28. The process of any one of embodiments 1 to 27, wherein said content of residual amorphous carbon in the graphitized carbon is less than 5 wt. %, or less than 2 wt. %, or less than 1 wt. %, or preferably less than 0.5 wt. %, after step (d).

Embodiment 29. The process of any one of embodiments 1 to 28, wherein said process comprises a carbon conversion from the carbon material to graphene and/or graphite of at least 30 mol %, at least 40 mol %, or at least 50 mol %.

Embodiment 30. The process of any one of embodiments 1 to 29, wherein said graphene has an average particle size or flake length between about 0.1 nm and about 5 mm, or between about 20 nm and about 1 mm, or between about 40 nm and about 500 μm.

Embodiment 31. The process of any one of embodiments 1 to 30, wherein said graphene has a structure comprising nanoflakes, nanoplatelets, carbon shells, or a combination thereof, preferably comprising nanoflakes or nanoplatelets.

Embodiment 32. The process of any one of embodiments 1 to 31, wherein said graphene has a structure comprising nanocones, nanohorns, nanodandelions, nanoribbons, nanopetals, or a combination thereof.

Embodiment 33. The process of any one of embodiments 1 to 32, wherein said graphite is synthetic graphite having a structure comprising synthetic graphite platelets or nanoplatelets.

Embodiment 34. The process of any one of embodiments 1 to 33, wherein said graphene comprises monolayer graphene, few-layer graphene (2 to 20 layers), or a combination thereof. Embodiment 35. The process of any one of embodiments 1 to 35, wherein said graphene and/or graphite has a carbon content of at least 80 mol %, at least 90 mol %, at least 95 mol %, or at least 97 mol %, or at least 98 mol %, or at least 99 mol %.

Embodiment 36. Material prepared by a process as defined in any one of embodiments 1 to 35.

Embodiment 37. Material comprising graphene and/or graphite supported on a matrix, said graphene and/or graphite comprising a carbon content of at least 95 mol %, or at least 97 mol %, or at least 98 mol %, or at least 99 mol %.

Embodiment 38. The material of embodiment 37, wherein said matrix comprises at least one of sand, quartz, silica, gravel, granite, cement, calcium carbonate, glass fibers, metal and metal alloy surfaces (e.g. rods, grids, fibers, rebar, etc.), metal and metal alloy powders (e.g. nanoparticles, microparticles, etc.), metal oxides (e.g. TiO₂, Al₂O₃, etc.), ceramics such as zeolites (e.g. sodium aluminosilicate zeolites), inorganic dyes, nanomaterials, boron nitrate (e.g. nanotubes or nanosheets), metal chalcogenides (e.g. transition metal dichalcogenides (TMDC)) or any other material that can withstand the above process conditions.

Embodiment 39. The material of embodiment 37 or 38, wherein said graphene has a structure comprising nanoflakes, nanoplatelets, carbon shells, or a combination thereof, preferably comprising nanoflakes or nanoplatelets.

Embodiment 40. The material of any one of embodiments 37 to 39, wherein said graphene has a structure comprising nanocones, nanohorns, nanodandelions, nanoribbons, nanopetals, or a combination thereof.

Embodiment 41. The material of any one of embodiments 37 to 40, wherein said graphite is synthetic graphite having a structure comprising synthetic graphite platelets or nanoplatelets.

Embodiment 42. The material of any one of embodiments 37 to 40, wherein said graphene has an average particle size or flake length between about 0.1 nm and about 5 mm, or between about 20 nm and about 1 mm, or between about 40 and about 500 μm.

Embodiment 43. The material of any one of embodiments 34 to 38, wherein said graphene comprises monolayer graphene, few-layer graphene (2 to 20 layers), or a combination thereof. Additional objects and features of the present compound, compositions, methods and uses will become more apparent upon reading of the following non-restrictive description of exemplary embodiments and examples section, which should not be interpreted as limiting the scope of the invention.

### DESCRIPTION OF THE FIGURES

FIGS. 1(a) to 1(i) present photographs of materials untreated (left) vs treated (right) with the present process, the materials presented being (a) gravel, (b) fiberglass, (c) quartz/silica, (d) sand, (e) copper wire, (f) stainless steel foil, (g) stainless steel coin, (h) steel rebar, and (i) stainless steel piece.

FIGS. 2(a) to 2(l) show backscattered scanning electron microscopy (SEM) images obtained at (a) ×2300, (b) ×1500, (c) ×7500, (d) ×20,000, (e) ×4000, (f) ×750, (g) ×5000, (h) ×5000, (i) ×7500, (j) ×5000, (k) ×5000, and (1) ×1000 magnifications for sample G-GC-1 prepared as in Example 2.

FIG. 3 presents optical microscope images obtained for (a) and (b) untreated fiber glass, and (c) to (f) sample G-FG-1 prepared at 800° C. as in Example 2.

FIG. 4 shows optical microscope images obtained for (a) untreated quartz-silica particles, (b) and (c) sample G-QS-7 prepared as in Example 2.

FIGS. 5(a) to 5(l) present transmission electron microscopy (TEM) images at various resolutions of sample G-QS-7 prepared in Example 2.

FIGS. 6(a) to 6(f) show SEM images of the surface of particles from sample G-QS-1 prepared in Example 2, where (c) shows a zoom-in of an area circled in (b), and (d) to (f) are in backscattered mode.

FIGS. 7(a) to 7(d) show backscattered SEM images of the surface of particles from sample G-QS-5 prepared in Example 2.

FIG. 8 presents Raman spectra (a) from 0 cm⁻¹ to 3500 cm⁻¹ and (b) from 1000 cm⁻¹ to 3250 cm⁻¹ obtained for sample G-QS-7 prepared as in Example 2.

FIG. 9 shows optical microscope images of (a) to (c) raw sand particles before treatment and (d) to (f) sample G-S-7 prepared as in Example 2.

FIGS. 10(a) to 10(d) show optical microscope images of sample G-S-1 prepared as in Example 2.

FIG. 11(a) to 11(f) present TEM images at various resolutions of fine sand fragments from sample G-S-6 prepared as in Example 2.

FIGS. 12(a) to 12(d) show SEM images of the surface of particles from sample G-S-1 prepared in Example 2.

FIG. 13 presents a Raman spectrum from 0 cm⁻¹ to 4500 cm⁻¹ obtained for sample G-S-1 prepared as in Example 2.

FIGS. 14(a) to 14(f) show backscattered SEM images of the surface of particles from sample G-SP-1 prepared in Example 2.

FIGS. 15(a) to 15(v) show SEM images using (a) backscattering, (b) secondary electrons mode, (c) to (f) backscattering of fiberglass bundles, (g) to (1) backscattering bundles cross-sections, and (m) to (v) cross section images obtained secondary electrons mode for sample G-FG-1 prepared in Example 2.

FIGS. 16(a) to 16(d) present the SEM images using secondary electrons mode on the surface and cross section of coper wire coated with in-situ grown graphene, sample G-CW-1 prepared in Example 2.

FIGS. 17(a) to 17(c) show the electron diffraction results (EDS) of copper wire coated with in situ grown graphene of sample G-CW-1 prepared in Example 2.

FIG. 18 presents a photograph of recycled asphalt pavement untreated (left) vs treated (right) as prepared with the present process described in Example 2.

FIGS. 19(a) to 19(c) show optical microscope images of sample G-BF-1 prepared as in Example 2.

FIGS. 20(a) to 20(d) show SEM images obtained at (a) ×100, (b) ×2500, (c) ×15,000, and (d) ×10,000, of the surface of basalt fibers from sample G-BF-1 prepared in Example 2.

FIGS. 21(a) and 21(b) show optical microscope images of sample G-GB-1 prepared as in Example 2.

FIGS. 22(a) to 22(c) show SEM images obtained at (a) ×100, (b) ×500, and (c) ×500, of the surface of glass beads from sample G-GB-1 prepared in Example 2.

FIGS. 23(a) and 23(b) show optical microscope images of sample G-RG-1 prepared as in Example 2.

FIGS. 24(a) to 24(e) show SEM images obtained at (a) ×10,000, (b) ×20,000, (c) ×950, (d) ×10,000, and (e) ×25,000 of the recycled glass from sample G-RG-1 prepared in Example 2.

FIG. 25 presents a photograph of recycled concrete untreated (left) vs treated (right) as prepared with the present process described Example 2.

### DETAILED DESCRIPTION

All technical and scientific terms and expressions used herein have the same definitions as those commonly understood by a person skilled in the art to which the present technology pertains. The definition of some terms and expressions used is nevertheless provided below. To the extent the definitions of terms in the publications, patents, and patent applications incorporated herein by reference are contrary to the definitions set forth in this specification, the definitions in this specification will control. The section headings used herein are for organizational purposes only and are not to be construed as limiting the subject matter disclosed.

The terminology used herein is for the purpose of describing particular embodiments only and is not intended to be limiting. It should be noted that, the singular forms “a”, “an”, and “the” include plural forms as well, unless the content clearly dictates otherwise. Thus, for example, reference to a composition containing “a compound” also contemplates a mixture of two or more compounds. It should also be noted that the term “or” is generally employed in its sense including “and/or” unless the context clearly dictates otherwise. Furthermore, to the extent that the terms “including”, “includes”, “having”, “has”, “with”, or variants thereof are used in either the detailed description and/or the claims, such terms are intended to be inclusive in a manner similar to the term “comprising”.

The term “about” or “approximately” means within an acceptable error range for the particular value as determined by one of ordinary skill in the art, which will depend in part on how the value is measured or determined, i.e., the limitations of the measurement system. For example, “about” can mean within one or more than one standard deviation, as per the practice in the art. Alternatively, “about” can mean a range of up to 20%, preferably up to 10%, more preferably up to 5%, and more preferably still up to 1% of a given value. Where particular values are described in the application and claims, unless otherwise stated the term “about” meaning within an acceptable error range for the particular value should be assumed.

The terms “graphene”, “graphite”, and “graphene and/or graphite” as used herein refers to synthetic materials generally recognized as being composed of layers of trigonal planar carbon in the form of a honeycomb lattice. Graphite includes multiple layers of this lattice, whereas graphene is generally understood to include fewer layers (e.g. 20 or less, or 10 or less). It should be understood that these terms also encompass graphene and/or graphite derivatives such as surface functionalized graphene and/or graphite, graphene and/or graphite oxides, reduced graphene and/or graphite oxides, and/or as including other carbon forms in combination with the graphene and/or graphite or derivatives thereof.

The expression “carbon-containing source”, “carbon source”, “carbon-containing material” and equivalent expressions refer to a material containing carbon atoms in a proportion sufficient to produce a graphitization of the material upon thermal treatment (but excluding an already graphitized product). Examples of carbon-containing materials include a carbohydrate-containing material, for instance from biomass, organic or petroleum-based oils, wax, alcohols, resins, gums, or a combination of two or more thereof.

The expressions “carbohydrate source”, “carbohydrate-containing material” or other equivalent expressions as used herein include any source or material comprising a carbohydrate (such as a sugar, starch and/or cellulose), and which may further comprise other materials, such as a material having a high carbon content (high carbon source). Non-limiting examples of carbohydrates include monosaccharides, disaccharides, oligosaccharides and polysaccharides, such as glycosaminoglycans, cellulose, starch (amylose, amylopectin), chitin, chitosan, inulin, cyclodextrin, and the like, and materials comprising them such as fruit peels and processing refuse (e.g. orange peel, pulp, etc.), cereal husks (e.g. rice husks), wood waste, bagasse, wastepaper, recycled cotton fabric, biochar, nut shells, and the like.

Non-limiting examples of wax include beeswax, carnauba wax, paraffin wax, soy wax, etc. Examples of gums include, without limitations, arabic gum, xanthan gum, cashew gum, guar gum, etc. Oils can be, for instance, from petroleum byproducts or be natural oils obtained from natural sources such as almonds, soya, canola, corn, cotton seed, grape seed, avocado oil, etc.

As used herein, the expression “restricted air” or “low air” as used herein when referring to thermal treatment conditions means an atmosphere which contains air naturally present (e.g. rather than added as a gas stream) upon closing a lid or covering a heating vessel. During the thermal treatment, this atmosphere will likely contain other gas generated during the thermal treatment, such as hydrogen gas generated in situ.

The present technology applies a modified pyrolysis method to obtain graphene and/or graphite originating from carbon-containing materials, including from bio-sources or from their waste as detailed above, where the graphene and/or graphite is grown on a matrix. These are but a few examples of carbon sources that can be used in combination or individually to produce graphene or graphite on a matrix using the present process.

While, as mentioned above, previous techniques require either a controlled atmosphere and high purity gases including hydrogen, or high voltage discharge that need highly controlled conditions, the present process does not require any of these controlled conditions. In fact, the synthesis of graphene and/or graphite in the present process may even occur under low air conditions.

Furthermore, the present process generally does not require further treatment such as a chemical pre-treatment of the carbon source and/or a chemical post-treatment of the obtained graphene and/or graphite. Accordingly, since the present method does not generally apply any harsh chemical conditions such as acids, bases, or organic solvents during the synthesis or to pre-treat the carbon source or its final product, the present method may be considered as eco-friendly and a cleantech. The method is also applicable to a one-pot synthesis setting.

In general terms, the present document therefore relates to a process for the preparation of a material comprising graphene and/or graphite on a matrix, said process comprising the steps of:
contacting a carbon-containing material as defined herein, and optionally a catalyst, with a matrix; and
thermally treating at a temperature above 550° C. to induce graphitization and produce a graphitized carbon;
wherein said process excludes injection of hydrogen or inert gas and in the presence of restricted air; and
wherein said matrix is a material that does not react or decompose when exposed to the thermal treatment conditions.

For instance, the contacting step may comprise spraying, soaking, mixing, the carbon-containing material on or with the matrix, wherein the carbon-containing material is optionally melted or dissolved to form a solution prior to spraying, soaking or mixing.

In one embodiment, the process for the preparation of graphene and/or graphite on a matrix comprises at least the steps of:
(a) preparing a solution containing a carbohydrate source, and optionally a catalyst, in a solvent (such as an aqueous solvent, e.g. water);
(b) contacting the solution from (a) with a matrix to obtain a mixture or a coating on the matrix;
(c) optionally drying the mixture or coating at a temperature of at least 100° C.; and (d) thermally treating at a temperature above 550° C. to induce graphitization and produce a graphitized carbon;
wherein said process excludes injection of hydrogen or inert gas and in the presence of restricted air; and
wherein said matrix is a material that does not react or decompose when exposed to the conditions of the process.

In one embodiment, the carbon source is a carbohydrate source comprising a monosaccharide, disaccharide, oligosaccharide or polysaccharide, or a mixture of two or more thereof. In another embodiment, the carbohydrate source comprises a monosaccharide or disaccharide, or a mixture thereof. In a further embodiment, the carbohydrate source comprises an oligosaccharide or polysaccharide, or a mixture thereof. In yet another embodiment, the carbohydrate source is or is from fruit peels and processing refuse (e.g. orange peel, pulp, etc.), cereal husks (e.g. rice husks), wood waste, bagasse, wastepaper, recycled cotton fabric, biochar, nut shells, and the like.

In other embodiments, the carbon source may also further comprise a high carbon material. For instance, the high carbon material is present in less than 50 wt. % of the total carbohydrate source, or less than 40 wt. %, or less than 30 wt. %, or less than 20 wt. %.

In the present process, any material which is stable at the present conditions could be used as the matrix. Non-limiting examples of such materials include materials like sand, quartz, silica, gravel, granite, basalt, cement, concrete, asphalt, calcium carbonate, glass (e.g. powder, beads, fibers, etc.), metal and metal alloy surfaces (e.g. rods, grids, fibers, rebar, etc.), metal and metal alloy powders (e.g. nanoparticles, microparticles, etc.), metal oxides (e.g. TiO₂, Al₂O₃, etc.), ceramics such as zeolites (e.g. sodium aluminosilicate zeolites), inorganic dyes, nanomaterials, boron nitrate (e.g. nanotubes or nanosheets), metal chalcogenides (e.g. transition metal dichalcogenides (TMDC)), or a combination of at least two thereof; or other materials such as diamonds or nanodiamonds. The present process may further be adjusted to obtain hetero-nanostructures which may be directly produced by adding additional nanomaterials (e.g. 2D materials) mixed or not with the carbon source or by co-growth (or co-synthesis) by adding the chemical precursors of the other nanomaterials. These nanomaterials may also be used as matrix. Non-limiting examples of metals or metal alloys include, for instance, copper, iron, steel, stainless steel, nickel, etc.

In some cases, a catalyst in included in step (a). Examples of catalysts include, without limitation, FeCl₃, metal or metal alloys (e.g. Cu, Ge, Ni) particles or powders, metal oxides, or a combination thereof.

The above step (b) may comprise any means of brining the solution of step (a) with the matrix, including mixing, soaking or spraying the matrix with the solution.

Thermal treatment step is preferably carried out under an atmosphere containing air, such as restricted air as defined herein, under normal atmospheric pressure or near normal atmospheric pressure. However, the presence of an inert gas is generally not necessary in the present process. The air present in the vessel is generally ambient from the vessel. The present process does not usually necessitate a flow of gas (air or other) passing through the vessel. For instance, the thermal treatment step is carried out in the presence of hydrogen which is generated in situ during the thermal treatment rather than by injection. The thermal treatment step may generally be carried out in a covered vessel, for instance, in a reaction vessel comprising a lid although the lid is preferably not sealed. If the covered vessel is a sealed vessel, then it can include pressure release valves or other pressure control means. Preferably, the covered vessel is not sealed and allows small gas exchanges with its immediate environment.

The vessel may be inserted in an oven, such as a tubular oven with or without various heating zones, or other types of oven system such as calciners, muffle furnaces, etc. The vessel may be any reaction container (such as, but not limited to, a crucible, tray, tube, etc.) that can withstand the reaction conditions without degradation and without significantly contaminating the material being treated.

The thermal treatment of step (d) comprises at least one step carried out at a temperature above 550° C., for instance within the range of about 550° C. to about 1400° C., or about 700° C. to about 1200° C., or about 800° C. to about 1100° C., or about 550° C. to about 1000° C., or about 550° C. to about 900° C.

In some examples of the present process, step (c) is present and carried out at a temperature within the range of 150° C. to 300° C., preferably 200° C. to 300° C., more preferably 200° C. to 250° C.

In some cases, such a step (c) may also further comprise breaking di-, oligo- and/or polysaccharide chains from the carbohydrate. Step (a) may be carried out in the presence of air, e.g., ambient air.

In some examples, the process may further comprise an intermediate thermal treatment carried out at a temperature within the range of 400° C. to 700° C. before step (d). In a preferred example, the intermediate thermal treatment is carried out at a temperature within the range of 500° C. to 650° C., or within the range of 500° C. to 600° C.

In various examples, the present process further comprises a step (e) after the thermal treatment step (d) comprising a second thermal treatment to eliminate residual amorphous carbon is carried out if such residual amorphous carbon is present. For example, step (e) may be included when the product obtained after step (d) comprises more than 10% by weight, or more than 5% by weight, or more than 3% by weight of residual amorphous carbon. For instance, such a thermal treatment may be carried out at a temperature within the range of 200° C. to about 600° C., or 200° C. to 350° C., in the presence of air.

In some cases, the process may further comprise a step of mechanically processing the material after step (d), or before or after step (e) if present. This mechanical treatment may be carried out by any conventional method, including, but not limited to, grinding, milling, pulverization, such as ball-milling, ring and puck grinding, pestle and mortar grinding, jet pulverizing, jet milling, roll mills, and other wet or dry micronization techniques, etc.

In preferred embodiments, the content of residual amorphous carbon in the graphene is less than 5 wt. %, or less than 2 wt. %, or less than 1 wt. %, or preferably less than 0.5 wt. %, after step (d).

The graphene is preferably produced by the present process through a carbon conversion rate from the carbon source to graphene and/or graphite of at least 20 mol %, at least 30 mol %, at least 40 mol %, or at least 50 mol %, or even more.

In preferred examples, the graphene produced has an average particle size or flake length 0.1 nm and about 5 mm, or between about 20 nm and about 1 mm, or between about 40 nm and about 500 μm. The structure of the graphene may also include one or more of nanoflakes, nanoplatelets, carbon shells, and other similar. Alternatively, the structure of the graphene may also include one or more of nanocones, nanohorns, nanodandelions, nanoribbons, nanopetals, and other similar.

The graphene may include monolayer graphene, few-layer graphene (2 to 20 layers), or a combination thereof. The graphite is synthetic graphite having more than 20 layers of carbon lattice, preferably the graphite is synthetic graphite having a structure comprising synthetic graphite platelets or nanoplatelets.

The graphene and/or graphite produced by the present process preferably has a carbon content of at least 80 mol %, at least 90 mol %, at least 95 mol %, or at least 97 mol %, preferably at least 98 mol %, or even at least 99 mol %.

In some cases, the process is carried out in an apparatus allowing for multiple thermal zones (such as a tubular furnace), where each heating step is carried out in a different heating zone as the material moves within the apparatus. In other cases, each heating step may be carried out within the same oven, in which the temperature is adjusted for each step. Alternatively, each heating step may be carried out in a different oven in which the thermal treatment temperature in adjusted for the specific step, each step being preceded by a loading stage and followed by a recovery stage.

The present method also allows synthesis in a tubular oven with or without various heating zones. Alternatively, a combination of calciners, muffle furnaces, or other types of ovens, would also be sufficient to prepare the graphene and/or graphite on matrix using the present process. Moreover, any other heating oven/device that simulates the conditions of the present synthetic method can be used to prepare the supported graphene and/or graphite and could even be applied to produce any matrix supported graphene- and/or graphite-like or carbon-nanostructure materials.

In sum, the present generally includes the growth of graphene and/or graphite (i.e. synthetic graphite) on a matrix from organic carbon sources, whether waste-derived or not, in ambient air conditions, i.e., without an additional gas flow, and without the use of a sealed, vacuum or inert environment. The graphene and/or graphite flakes produced promote the complete coating of the object forming the matrix that is mostly resistant to mechanical exfoliation. The number of layers of the graphene and/or graphite is tunable according with the requirements of the matrix, object or application. The coating thickness may also be adjusted and may vary from 20 nm up to hundreds of microns depending on the desired thickness and requirements of the application. The method is cost effective and may be applied to a single source of carbon or to multiple carbon sources.

Also contemplated are processes for preparing graphene and/or graphite or a material containing graphene and/or graphite comprising the preparation of a material containing graphene and/or graphite on a matrix as defined herein, and further chemically treating the material to remove the matrix when such matrix has been especially selected for that purpose.

The material prepared by the present method may be used in a broad variety of known graphene applications, for instance, as additives in concrete, asphalt, composites, anti-corrosion coatings and paints, 3D printing, electrodes, solar panels, flexible panels, thermal foils, sensors, quantum computing, heteronanostructures, new generation of metal-organic framework (MOF) and covalent organic framework (COF), water and gas filtration systems, optical sensors, smart glass, stray light reducing black coatings, etc.

The recitation of an embodiment or example for a variable herein includes that embodiment or example as a single embodiment or example or in combination with any other embodiments, examples or portions thereof. The recitation of an embodiment herein includes that embodiment as any single embodiment or in combination with any other embodiments or portions thereof.

### Examples

The following non-limiting examples are illustrative embodiments and should not be construed as further limiting the scope of the present invention. These examples will be better understood with reference to the accompanying figures.

Unless otherwise indicated, all numbers expressing quantities of ingredients, reaction conditions, concentrations, properties, stabilities, and so forth used in the specification and claims are to be understood as being modified in all instances by the term “about.” At the very least, each numerical parameter should at least be construed in light of the number of reported significant digits and by applying ordinary rounding techniques. Accordingly, unless indicated to the contrary, the numerical parameters set forth in the present specification and attached claims are approximations that may vary depending upon the properties sought to be obtained.

Notwithstanding that the numerical ranges and parameters setting forth the broad scope of the embodiments are approximations, the numerical values set forth in the specific examples are reported as precisely as possible. Any numerical value, however, inherently contain certain errors resulting from variations in experiments, testing measurements, statistical analyses and such.

### Example 1—General Method

The modified pyrolysis can be achieved through a feed-stock side, heating area that can be subdivided or not into various heating zones, with or preferably without inert gas or any reducing gas or agent. This technique is robust to produce the graphene and/or graphite (i.e. synthetic graphite) even in a restricted air atmosphere. Additionally, the number of layers the graphene or thickness of the synthetic graphite may be modified with residence time, the matrix used and the presence or absence of a catalyst.

According to one example of the process, an aqueous solution of an organic powder source of carbon (at least 100 g to 1000 g) which may additionally include a catalyst such as FeCl₃ is prepared. The source of carbon may also be melted instead of dissolved if appropriate. This aqueous solution is then added to a matrix (between 1 and 2 kg), for instance, by mixing, soaking or spraying the aqueous solution to form a coated matrix or mixture. The weight ratio of carbon:matrix generally varies between 1:1000 and 1:10. The material obtained is then placed in a container, and dried, if necessary, at a temperature of at least 100° C.

Following the drying step, the material is placed into a vessel/tray/tube (e.g., crucibles, etc.), covered with a lid (but not sealed) and the temperature is raised to a higher temperature (e.g., between 550° C. to 1400° C.), in the presence of air (naturally present in the vessel/tray/tube), during 1 minute to 240 minutes. During this step, in situ generation of hydrogen may occur. Subsequently, during the cooling stage, the material is kept undisturbed until it reaches room temperature or a temperature cold enough for handling.

Subsequently, when the matrix includes nanoscale or microscale material, the material obtained may be treated mechanically (e.g., grinded, milled, etc.) using any compatible available method to obtain a final sample.

Variations on this process include inert gas (e.g., nitrogen or argon) vs air atmosphere, but the above conditions are preferred. Other variations include an additional thermal treatment before the higher temperature treatment carried out at temperatures, for instance ranging from 400° C. to 700° C., under restricted air. The obtained sample may also be mechanically treated before being treated at the higher temperature.

### Example 2—Preparation of Matrix Supported Graphene

The present example describes synthetic methods used for preparing the supported graphene samples used for further analysis in Example 3. Method 1 was used for the preparation of all samples except for samples prepared using fiber glass as a matrix, which were prepared using Method 2.

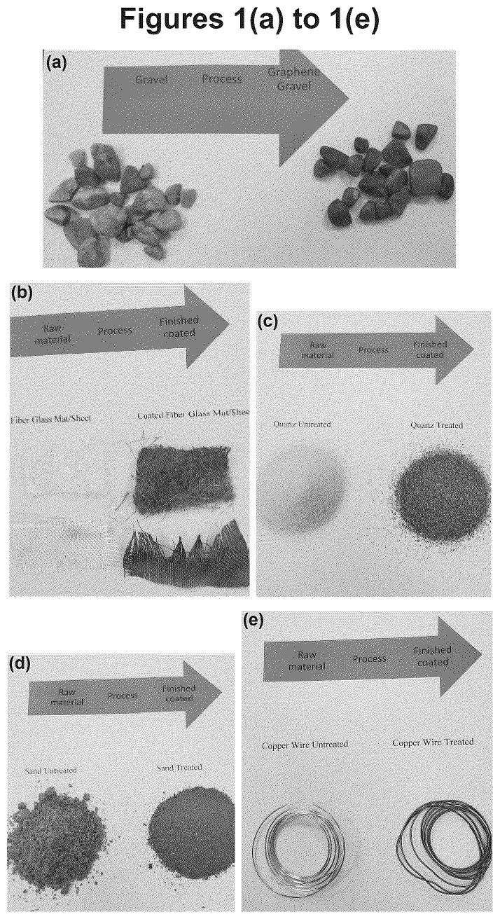

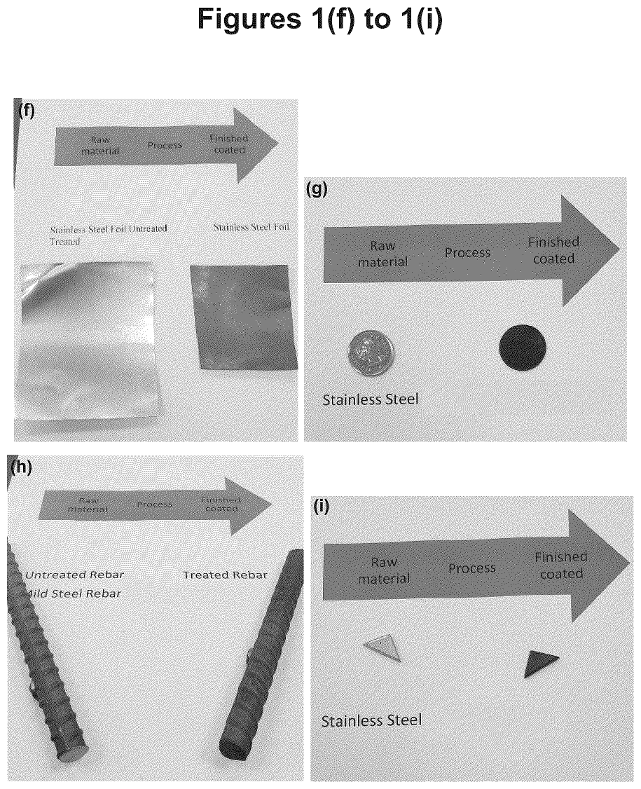

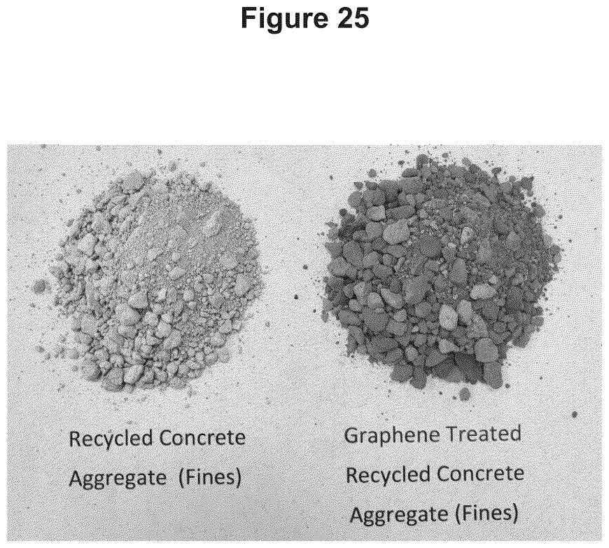

FIGS. 1(a) to 1(i) present photographs of materials untreated (left) vs treated (right) with the below processes, the materials presented being (a) gravel, (b) fiberglass, (c) quartz/silica, (d) sand, (e) copper wire, (f) stainless steel foil, (g) stainless steel coin, (h) steel rebar, and (i) stainless steel piece. Similarly, FIGS. 18 and 25 show photographs of materials untreated (left) vs treated (right) with the below process for recycled asphalt pavement (G-RAP-1) and recycled concrete aggregate (G-RC-1), respectively.

### Method 1:

A solution containing polysaccharide (PS) and the catalyst when present is prepared in water and applied to the matrix. When the matrix is a metal surface (such as copper wire, stainless steel coins, sheet, steel rebar, etc.), the solution is sprayed on the surface. Amounts of PS and catalyst used in each procedure are detailed in Table 1. The sample is then introduced into a vessel (crucible, etc.) treated at a temperature T₁ of at least 100° C. (or about 220° C.) for a duration D₁ of at least 2 minutes under ambient air. A covered vessel may be used in this case. When the solution is sprayed, this first treatment step is excluded, and the coating is dried at the beginning of the next step. The temperature is then increased to attain a thermal treatment temperature T₂, under air from the covered vessel (without gas flow, vessel covered but now sealed), for a D₂ duration. During this step, hydrogen is self-generated in situ into the crucible. Subsequently, the material is kept undisturbed until the material reaches room temperature, or cold enough for handling (cooling stage).

### Method 2:

A solution is prepared based on 6 g PS per 160 ml water with 0.3 g FeCl₃. Sand is soaked with the solution at a ratio of 160 ml per kg of sand. Total sand was 2 kg per crucible. The sand was dried at 800° C. for 39 minutes. The fiberglass mat weight's is about 2 g and the fiberglass sheet's weight is of about 3 grams. The weight of solution soaked on each fiberglass mat and sheet is about 1.5 g each. Three crucibles of sand and fiberglass are treated in the same kiln at 800° C. for 30 minutes, 45 minutes and 60 minutes. The samples of the fiberglass are laid flat on the surface of the sand at the 30% level and 50% volume level in the soaked sand and heated in the crucible covered with a lid (not sealed) and removed after each time period to cool on the bricks outside the kiln. All steps of the process are carried out without injection of hydrogen or inert gas and in the presence of air from the crucible (no gas stream added).

### Method 3:

In a pan mixer, 1 kg of recycled asphalt pavement (RAP), fines or coarse aggregate, was mixed with a 10% w/w polysaccharide aqueous solution with ferric chloride (1 w/w %). The coated RAP was placed into a metal tray to dry at 220° C. (Ti) for 1 hour. After the surface of the aggregate has been dried, a graphite crucible was filled to the top and the crucible was covered with a steel lid (air-tight not needed). The crucible was placed in a muffle furnace and the temperature was raised to 650° C. (T₂) and held for 30 minutes (D₂). The crucible with the lid were removed from the furnace and transferred on to a cooling area for 2 hours. After crucible has cooled, the steel lid was removed, and the graphene/RAP sample was placed on a steel tray for further cooling.

### Method 4:

In a container, 100 g of basalt fibers was mixed with 10 g of a polysaccharides source along with 1 g of a 10% (w/w) of ferric chloride aqueous solution. Additionally, 10 g of polysaccharide and ferric chloride (enough to obtain 10% w/w) were mixed with 200 g of distilled water. Following, the basalt fibers coated with the polysaccharide mixture were air dried. The damp basalt fibers were transferred to a graphite crucible and covered with a fiber glass mat to prevent extra carbon from the sacrificial layer to interact with the basalt fibers. 100 g of dried polysaccharide treated at 220° C. were used as sacrificial layer on the surface of the fiberglass. The crucible was covered with a stainless-steel lid and inserted into a furnace that was ramped to 650° C., followed by a plateau at the same temperature for 30 minutes. After that, the sample was transferred to a cooling area and the excess of sacrificial polysaccharide was removed when the sample reached 100° C. The final graphene/basalt fiber was stored in an airtight container.

### Method 5:

3M XLD 3000 glass beads (100 g) were treated with 10% w/w of a polysaccharide aqueous solution comprising iron chloride. Sample was initially mixed with 300 g distilled water and air dried prior to the thermal treatment. The top ¼″ of treated beads in the crucible may have reduced carbon levels as no sacrificial carbon or fiberglass cover was used in the heating. The coated glass beads were placed in a muffle furnace and the temperature was ramped to 650° C., followed by a plateau at the same temperature for 30 minutes. The crucible with the lid was moved to a cooling area for 2 hours. After the crucible has cooled, the steel lid was removed, and the final sample was placed on a steel tray for further cooling.

### Method 6:

Fine ground recycled glass powder was treated with dry polysaccharide thermally treated at 220° C. milled powder containing ferric chloride (brown color). Then, the temperature was raised to 650° C. for 30 minutes. The crucible with the lid was moved to a cooling area for 2 hours. After the crucible cooled, the steel lid was removed, the final sample was placed on a steel tray for further cooling.

### Method 7:

In a container, 15 g of polysaccharide was stirred in 200 ml of water until dissolved completely. Further, 2 ml of a 10% (w/w) solution of anhydrous ferric chloride was added to the solution. Then, the polysaccharide solution with ferric chloride was mixed to 1 kg of recycled concrete aggregate (fines or coarse aggregate) in a pan mixer until the aggregate was fully wetted. The wetted aggregate was transferred into a metal tray to dry at 220° C. for 1 hour. After the surface of the aggregate was dried, the mixture was transferred to a graphite crucible. The crucible was then covered with a steel lid (airtight not needed). The sample was inserted in a muffle furnace and the temperature was raised to 650° C. and maintained for 30 minutes. The crucible was removed from the furnace with the lid on to a cooling area for 2 hours. After the crucible cooled, the steel lid was removed, and the graphene/concrete was placed in a steel tray for further cooling.

A range of conditions were tested with various matrices, some of which are presented herein. The conditions used for preparing each of samples analyzed in Example 3 are summarized in Table 1.

TABLE 1
Preparation conditions for supported graphene samples

| | | PS wt. ratio vs | | FeCl₃ wt. ratio vs | | | |
|---|---|---|---|---|---|---|---|
| | | matrix (R) or | | matrix (R) or | | T₂ | D₂ |
| Sample | Matrix | PS soln conc. (S) | | FeCl₃ soln conc. (S) | | (° C.) | (minutes) |
| G-S-1 | Sand | 6 g/kg | (R) | 0.3 g/kg | (R) | 900 | 10 |
| G-S-2 | Sand | 6 g/kg | (R) | 0.3 g/kg | (R)^{a} | 900 | 10 |
| G-S-3 | Sand | 6 g/kg | (R) | 0.3 g/kg | (R) | 900 | 10 |
| G-S-4 | Sand | 6 g/kg | (R) | 0.3 g/kg | (R) | 850 | 30 |
| G-S-5 | Sand | 6 g/kg | (R) | 0.3 g/kg | (R) | 850 | 10 |
| G-S-6 | Sand | 6 g/kg | (R) | 0.3 g/kg | (R) | 800 | 30 |
| G-S-7 | Sand | 6 g/kg | (R) | 0.3 g/kg | (R) | 900 | 30 |
| G-QS-1 | quartz/silica | 6 g/kg | (R) | 0.3 g/kg | (R) | 900 | 10 |
| | (Silica No 30) | | | | | | |
| G-QS-2 | quartz/silica | 3 g/kg | (R) | 0.3 g/kg | (R) | 700 | 10 |
| | (Silica No 30) | | | | | | |
| | with Al | | | | | | |
| G-QS-3 | quartz/silica | 3 g/kg | (R) | 0.3 g/kg | (R) | 700 | 10 |
| | (Silica No 30) no Al | | | | | | |
| G-QS-4 | quartz/silica | 0.5 g/kg | (R) | 0.3 g/kg | (R) | 700 | 5 |
| | (Silica No 30) no Al | | | | | | |
| G-QS-5 | quartz/silica | 0.5 g/kg | (R) | 0.3 g/kg | (R) | 700 | 10 |
| | (Silica No 30) no Al | | | | | | |
| G-QS-6 | quartz/silica | 20 g/kg | (R) | 0.3 g/kg | (R) | 900 | 20 |
| | (Silica No 30) no Al | | | | | | |
| G-QS-7 | quartz/silica | 6 g/kg | (R) | 0.3 g/kg | (R) | 900 | 10 |
| | (Silica No 30) no Al | | | | | | |
| G-GG-1 | gravel/granite | 25 g/kg | (R) | — | | 850 | 30 |
| G-GC-1 | gravel/CaCO₃ | 20 g/kg | (R) | 0.3 g/kg | (R) | 850 | 10 |
| G-FG-1 | fiber glass | See method 2 | | See method 2 | | 800 | 30-60 |
| G-CW-1 | copper wire | 6 g/160 mL | (S) | — | | 900 | 5 |
| G-CW-2 | copper wire | 6 g/160 mL | (S) | 0.3 g/160 mL | (S) | 800 | 45 |
| G-SC-1 | stainless steel coin | 6 g/160 mL | (S) | 0.3 g/160 mL | (S) | 700 | 1 |
| G-SR-1 | steel rebar | 6 g/160 mL | (S) | 0.3 g/160 mL | (S) | 700 | 1 |
| G-SS-1 | carbon-rich | 6 g/160 mL | (S) | 0.3 g/160 mL | (S) | 700 | 5 |
| | stainless steel | | | | | | |
| | sheet | | | | | | |
| G-SP-1 | stainless steel | 6 g/160 mL | (S) | 0.3 g/160 mL | (S) | 700 | 5 |
| | piece | | | | | | |
| G-RAP-1 | recycled asphalt | See method 3 | | See method 3 | | 650 | 30 |
| | pavement | | | | | | |
| G-BF-1 | basalt fibers | See method 4 | | See method 4 | | 650 | 30 |
| G-GB-1 | glass beads | See method 5 | | See method 5 | | 650 | 30 |
| G-RG-1 | recycled glass | See method 6 | | See method 6 | | 650 | 30 |
| G-RC-1 | recycled concrete | See method 7 | | See method 7 | | 650 | 30 |
| | aggregate | | | | | | |

^{a}Followed by ring and puck milling.

### Example 3—Physicochemical Characterization of Samples

Samples prepared using the present process were analyzed by various methods, including scanning electron microscopy (SEM), optical microscopy (OM), transmission electron microscopy (TEM), electron diffraction spectrometry (EDS), and Raman spectroscopy. The SEM results were obtained on the samples as received. No further treatment or coating was performed on the surface of the materials before analysis. The following summarize part of the results obtained.

### (i) Characterization of Graphene on Gravel (G-GG-1):

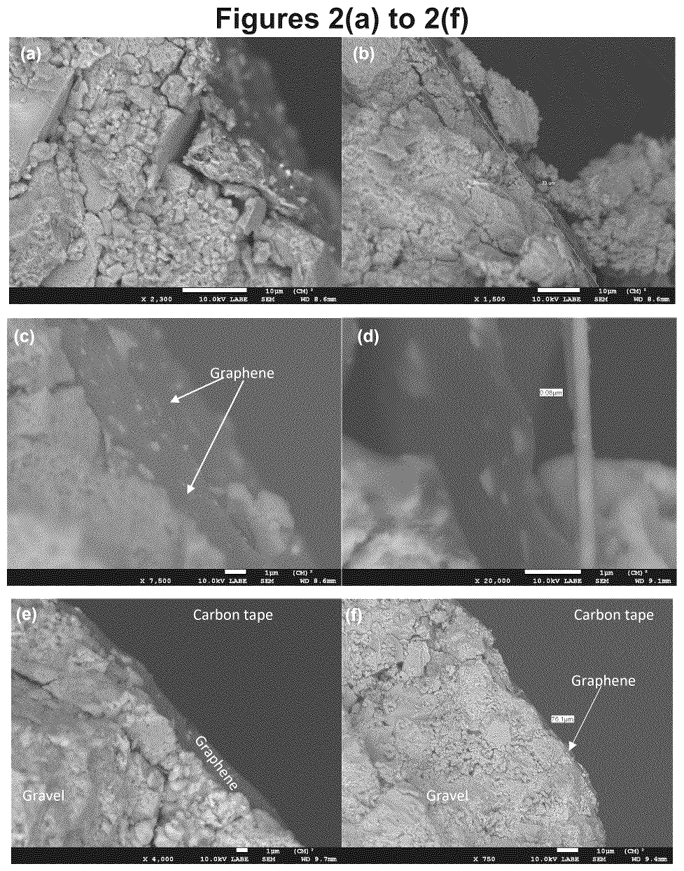

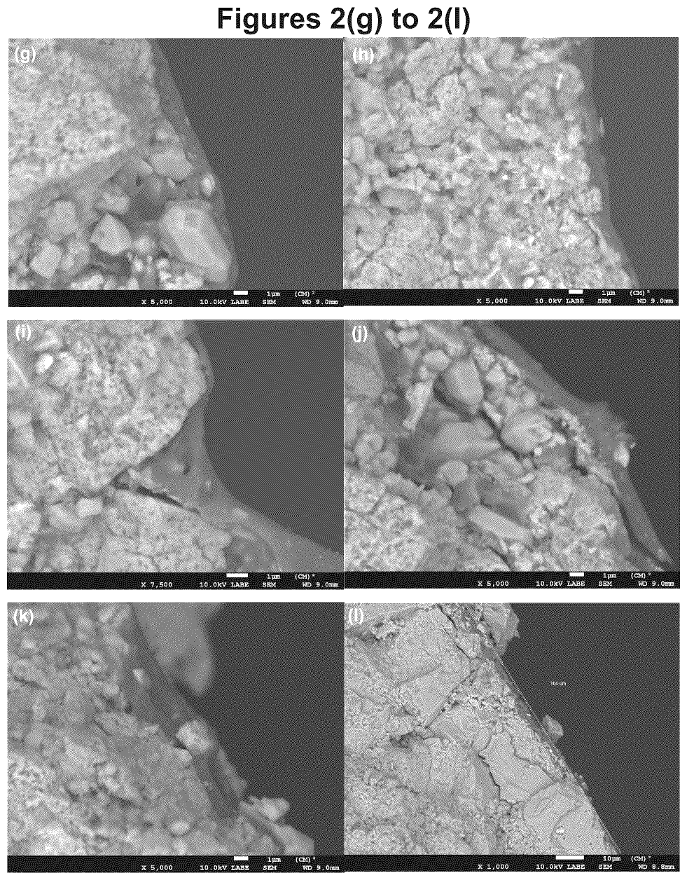

SEM images were obtained at various resolutions for sample G-GG-1 as prepared in Example 2. FIGS. 2(a) to 2(l) show the backscattered SEM images on a cross-section obtained at various magnifications for sample G-GG-1. The images show the in-situ grown graphene (in black) and the gravel (bright fragments). The length of the graphene varies from 73 μm to 104 μm, whereas the thickness ranges from 30 nm to 80 nm. For instance, in FIG. 2(b), the length of the graphene is of at least 73 μm, while graphene on FIGS. 2(f) and 2(l) images has a length of about 76 μm and about 76 μm, respectively.

### (ii) Characterization of Graphene on Fiberglass (G-FG-1):

Graphene on glass fibers sample G-FG-1 prepared as in Example 2 at 800° C. were characterized by OM and SEM.

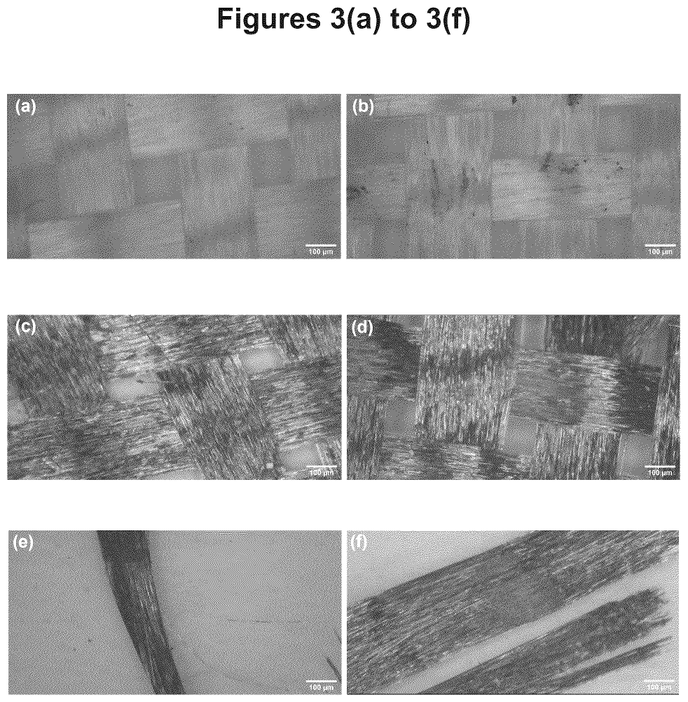

FIG. 3 shows the OM images of samples before (3(a) and 3(b)) and after (3(c)-3(f)) in situ growth of graphene. The images of FIGS. 3(c) to 3(f) clearly show the formation of graphene on the glass fibers in comparison to the untreated fibers.

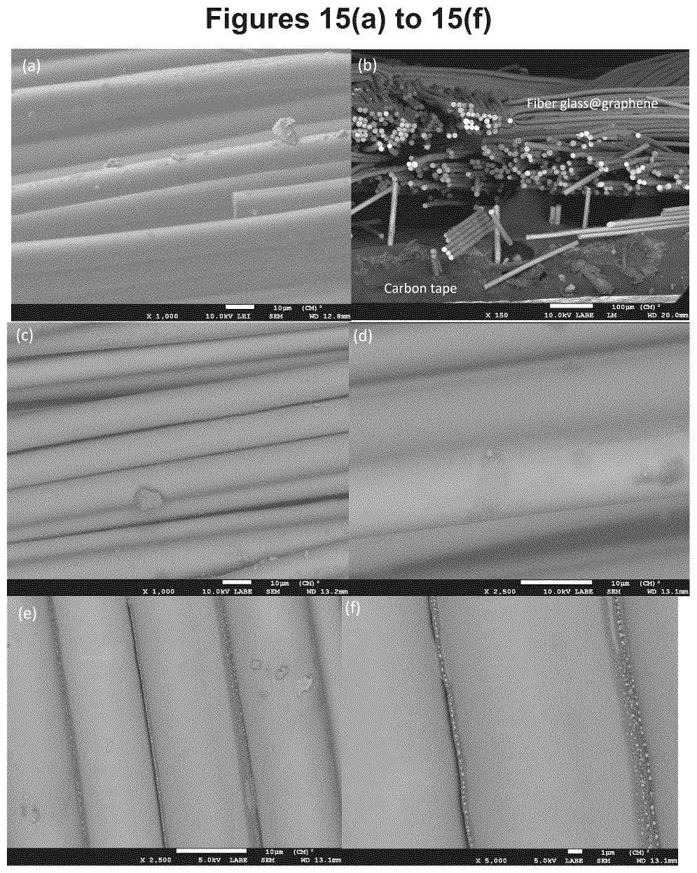

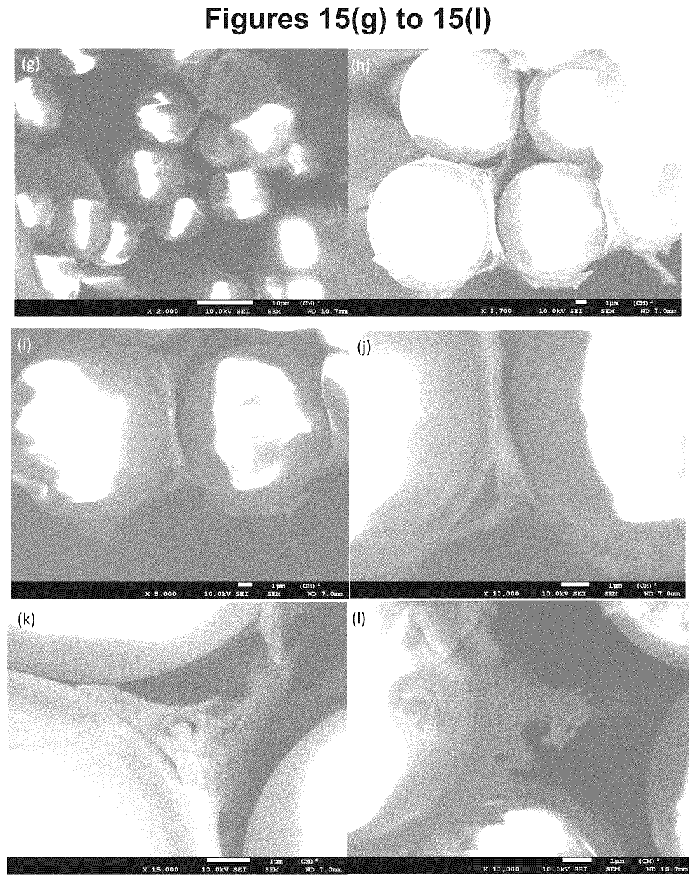

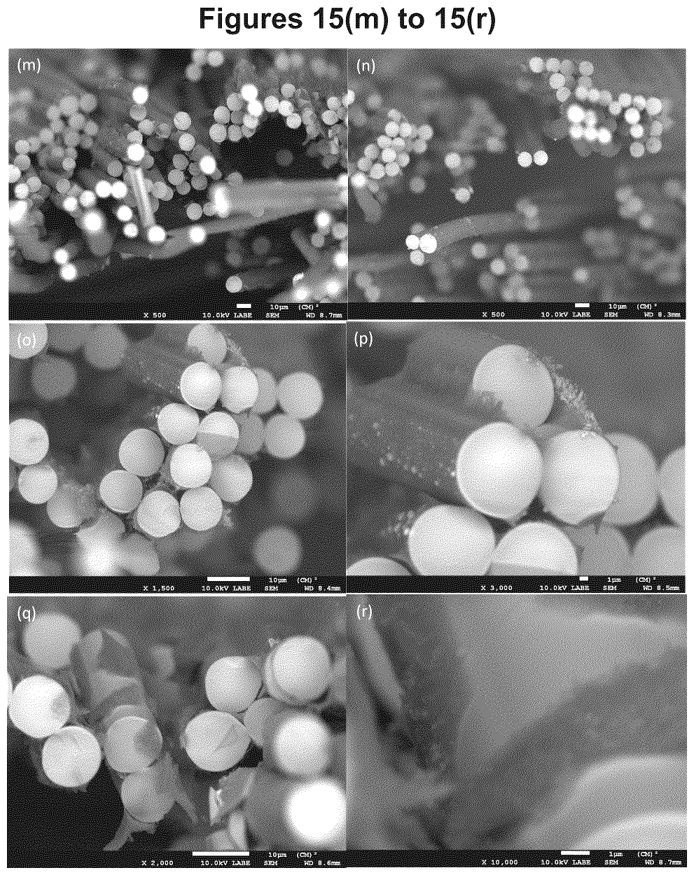

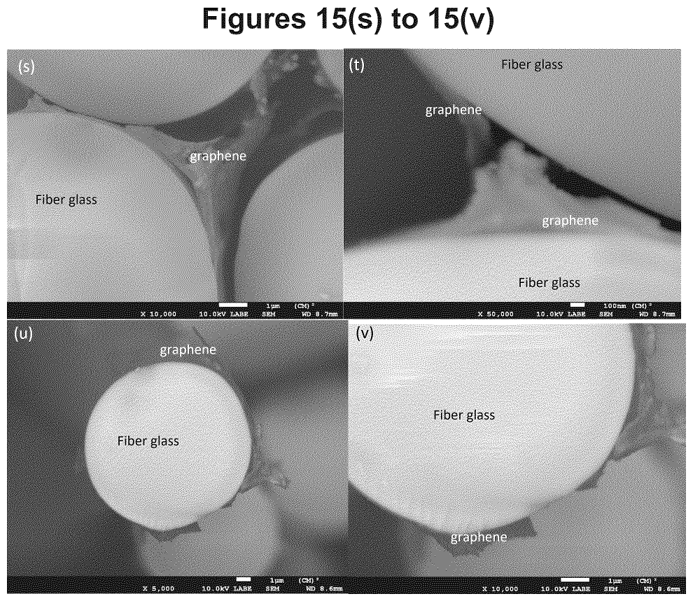

FIGS. 15(a) to 15(v) show SEM images using backscattering and secondary electrons mode on the surface and cross section of fiber glass mat coated with in-situ grown graphene, sample G-FG-01. Image (a) was acquired in backscattering mode and image (b) was acquired in secondary electrons mode show low-magnification results of the surface of the fiber glass with in situ grown graphene. FIGS. 15(c) to 15(f) show backscattering images of fiber glass bundle coated by graphene. FIGS. 15(g) to 15(l) show backscattering images of cross section bundles of fiber glass coated with in situ grown graphene. Bright areas show part of the fiber glass core. Partial lifting of the graphene from the surface of the fiber glass is attributed to the treatment with liquid nitrogen used to obtain the cross section cut. FIGS. 15(m) to 15(v) show cross section images of fiber glass with in situ grown graphene obtained using secondary electrons mode. The in-situ grown graphene covers all the fiber glass. So, the graphene length is limited by the fiber glass length only.

(iii) Characterization of Graphene on Quartz/Silica (G-QS-7):

Samples G-QS-7 of graphene on quartz/silica prepared in Example 2 were characterized by OM, TEM and Raman spectroscopy.

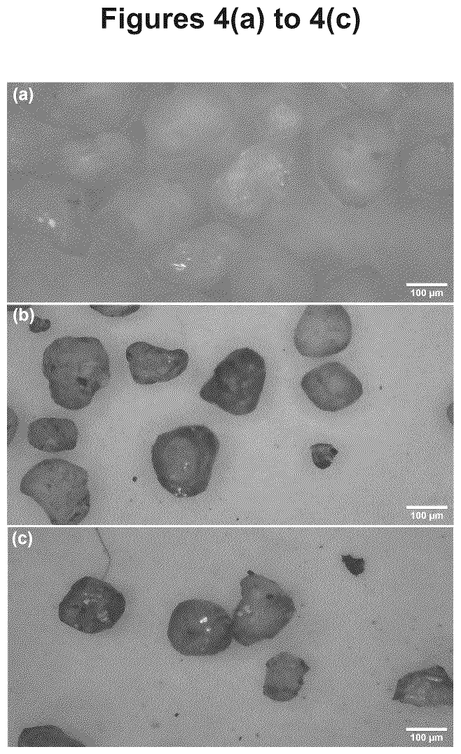

FIG. 4(a) shows an OM image of quartz/silica particles before treatment while the images presented in FIGS. 4(b) and 4(c) are of sample G-QS-7.

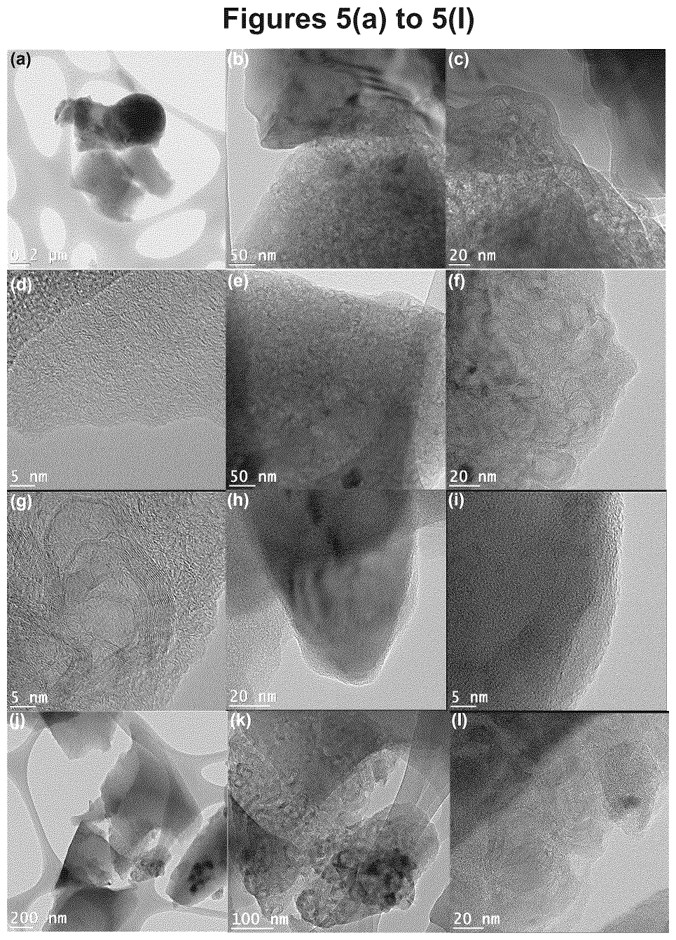

FIGS. 5(a) to 5(l) show TEM images of sample G-QS-7 of graphene grown on quartz-silica particles. For instance, FIGS. 5(a) to 5(c) illustrate in situ growth of graphene around and between the quartz/silica particles, FIG. 5(d) to 5(f) show high magnification and other angles of in situ grown graphene, FIGS. 5(g) to 5(i) show that the quartz/silica particles are coated with in situ grown graphene, and FIG. 5(j) to 5(l) illustrate the quartz/silica particles presenting in situ grown graphene with shell-shaped/round sheets.

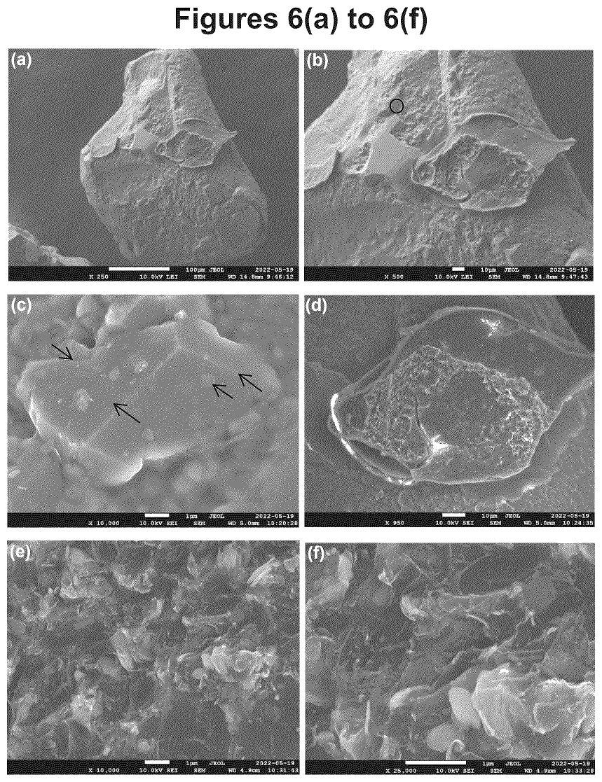

FIGS. 6(a) to 6(f) show SEM images of the surface of particles from sample G-QS-1. The image presented in (c) shows a zoom-in of an area circled in image (b). An in situ grown graphene coats the surface of the quartz/silica on image (c). The red arrows indicate the grown graphene connecting fragments of quartz/silica. Additionally, images (d) to (f) were taken in backscattered mode showing the contrast between the graphene (in black) and the silica/quartz (brighter areas). These images demonstrate the in situ growth of graphene.

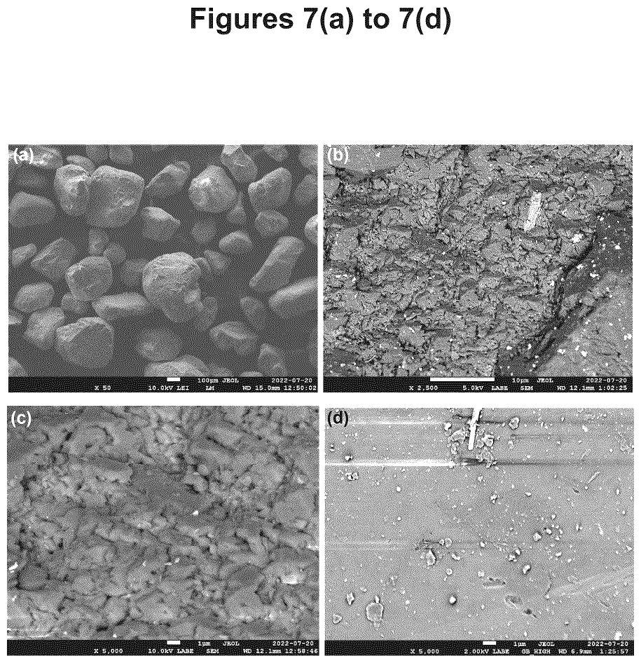

FIGS. 7(a) to 7(d) show backscattered SEM images of the surface of particles from sample G-QS-5. The images show the in situ grown graphene (in black). Images (c), and (d) show single layer and few-layer graphene on the surface of the quartz/silica grains. The results demonstrate the versatility of the method for the in situ growth of single layer graphene, few-layer graphene, and graphene platelets.

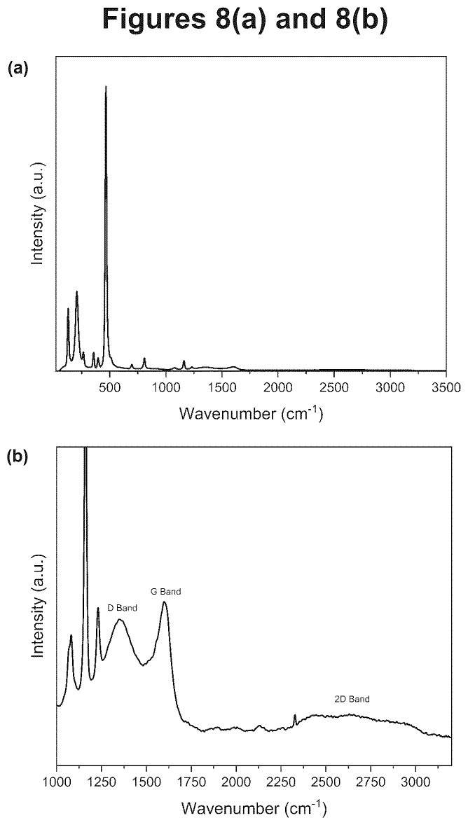

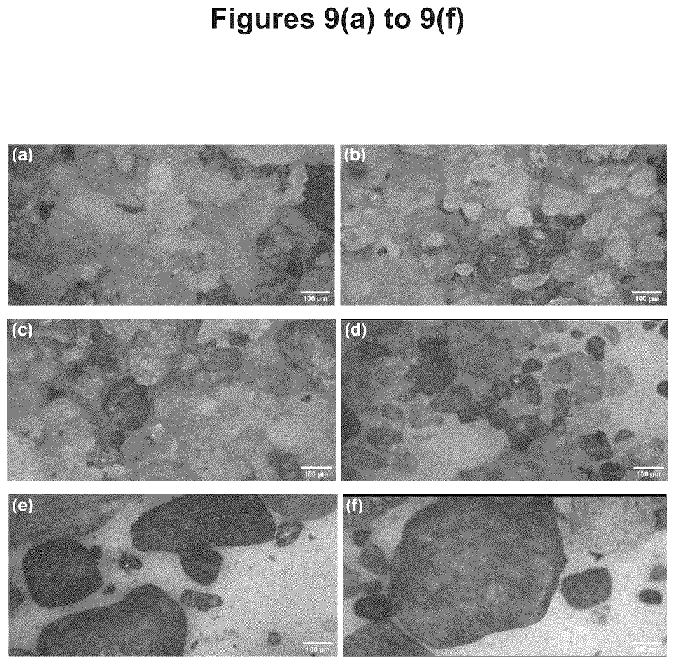

FIG. 8 present results of the analysis by Raman spectroscopy of sample G-QS-7 of graphene grown on quartz-silica particles. In the spectrum shown in FIG. 8(a), the peaks within the range of 100 cm⁻¹ to 1000 cm⁻¹ represent the fingerprint peaks of α-quartz. Thus, the peak of α-quartz at 462 cm⁻¹ corresponding to the νₛ(Si—O—Si) mode, and of dolomite at 1099 cm⁻¹ corresponding to the symmetric stretching mode for the oxygen atoms of carbonate ions, νₛ(CO₃²⁻). FIG. 8(b) shows an enlargement of the 1000 cm⁻¹-3250 cm⁻¹ of the spectra, which includes peaks associated with graphene. The D band (˜1350 cm⁻¹), the most prominent defect-related band, presents a high intensity. The bands located at ˜1100-1250 cm⁻¹ correspond to D* band and the peak at 1605 cm⁻¹ corresponds to the G band. The peaks between 2430-2940 cm⁻¹ represent the 2D and D+D* bands.

### (iv) Characterization of Graphene on Sand (G-S-1, G-S-6 and G-S-7 . . . ):

Samples G-S-1 and G-S-7 of graphene on sand prepared in Example 2 were characterized by OM. The sample G-S-6 was also characterized by TEM, while the sample G-S-1 was evaluated by Raman spectroscopy.

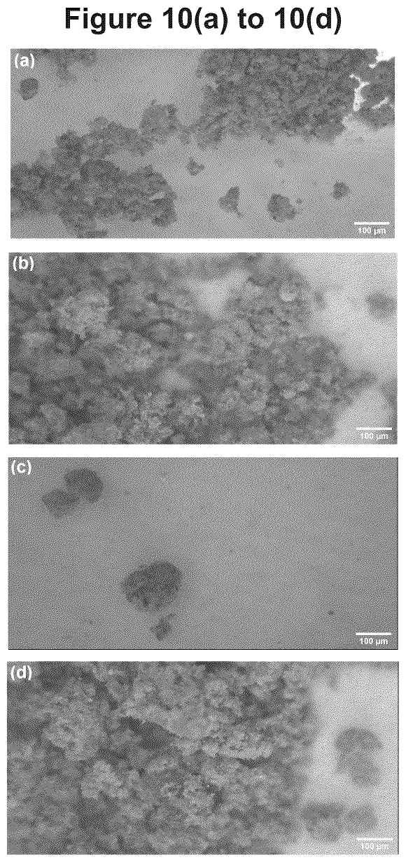

FIGS. 9(a) to 9(c) show OM images of raw sand particles before treatment while the images presented in FIGS. 9(d) to 9(f) show optical images of sample G-S-7 treated at 900° C. on which a dark deposit is visible. FIGS. 10(a) to (d) show OM images of fine sand treated at 900° C. (sample G-S-1).

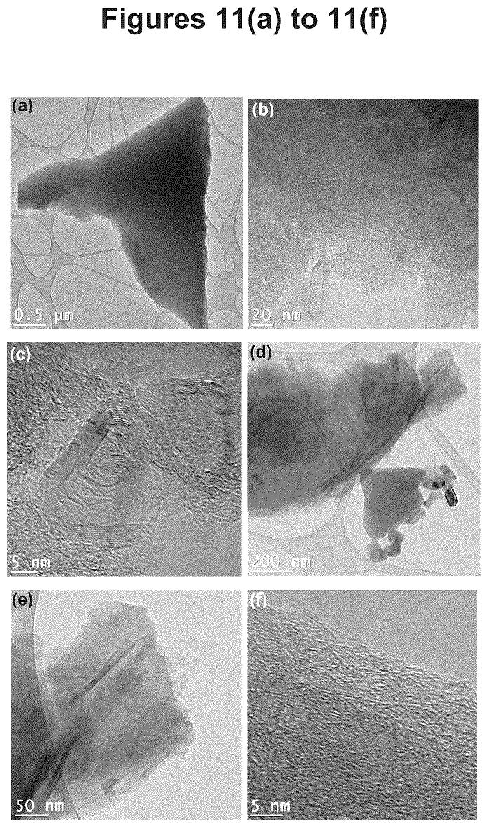

TEM images of sample G-S-6 at various resolutions are presented in FIGS. 11(a) to 11(f). The image show various sand grain fragments coated with in situ grown graphene.

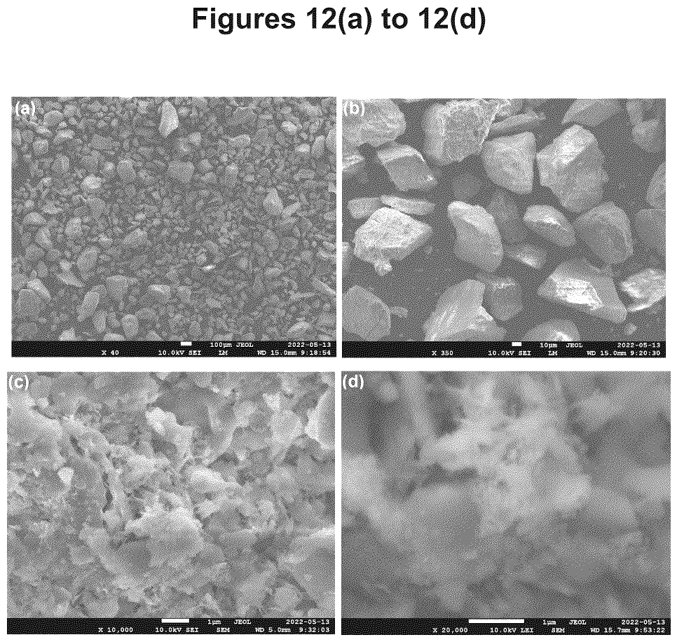

FIGS. 12(a) to 12(d) show SEM images of the surface of sand particles from sample G-S-1. The images show graphene grown in situ on the surface of the sand particles. Images (c) and (d) show that graphene has grown in situ on the surface and in between the sand particles.

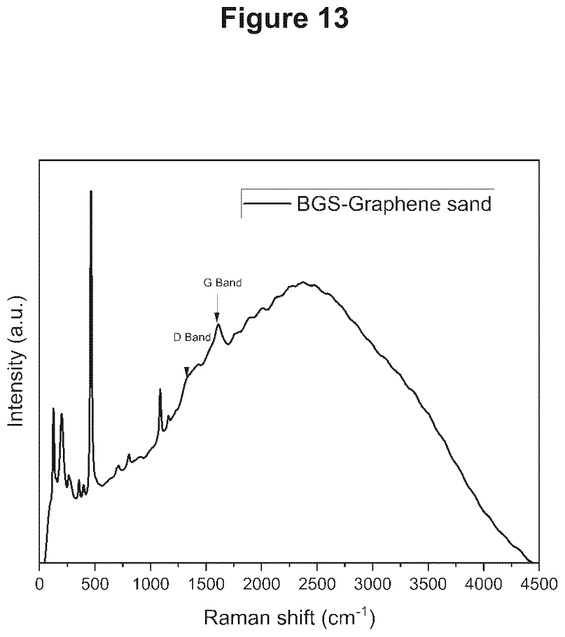

FIG. 13 shows a Raman spectrum for sample G-S-1. The Raman spectrum shows a mix of peaks related to quartz, dolomite, gypsum, etc. Peaks from the G and D bands related to graphene are found near 1600 cm⁻¹ and 1420 cm⁻¹, respectively. The 2D and potential other peaks were covered by luminescence.

### (v) Characterization of Graphene on Stainless Steel Pieces (G-SP-1):

Graphene grown on stainless steel pieces, i.e., sample G-SP-1 prepared as in Example 2, was analyzed by SEM.

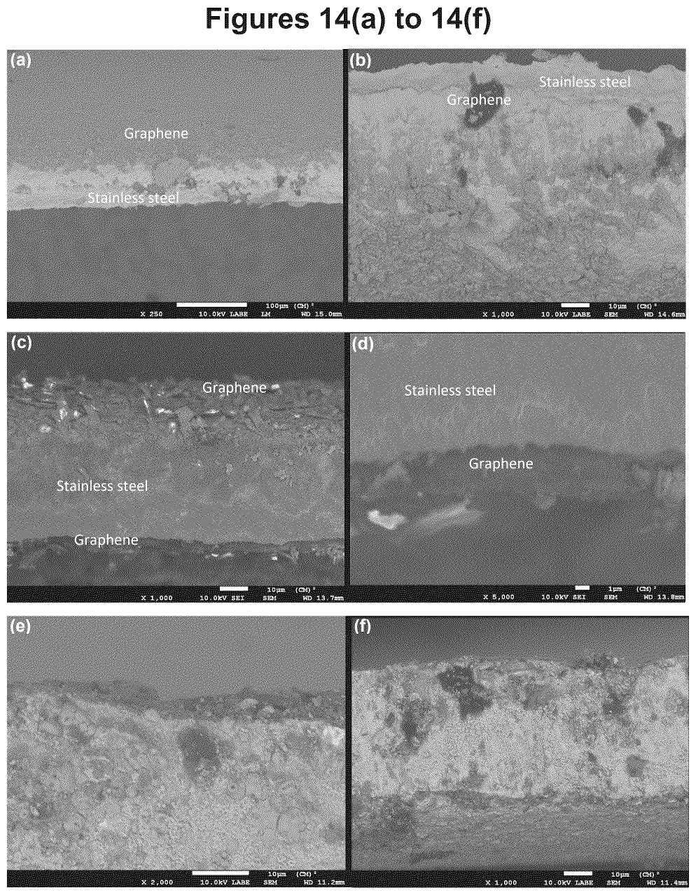

The images appearing in FIGS. 14(a) to 14(f) show backscattered SEM images of a cross-section of a stainless steel piece (from sample G-SP-1). The images show the in situ grown graphene (in black) and the stainless steel piece (bright part) on which the graphene has formed.

The length of the graphene follows the size of the stainless steel piece. The graphene on the surface became flaky from the pressure applied to break the stainless steel piece for analysis.

Images (b) and (f) show the stainless steel piece on an 70° inclination angle in order to expose the core of the stainless steel directly to the detector. The graphene piece in the image (black) has most likely been displaced during cutting. Image (c) shows the core of the stainless steel piece as well as both sides of the metal with in situ grown graphene on the surface of the metal.

### (vi) Characterization of Graphene on Copper Wire (G-CW-1):

Sample G-CW-1, containing graphene gown on copper prepared as in Example 2, was also analyzed by SEM and electron diffraction (EDS).

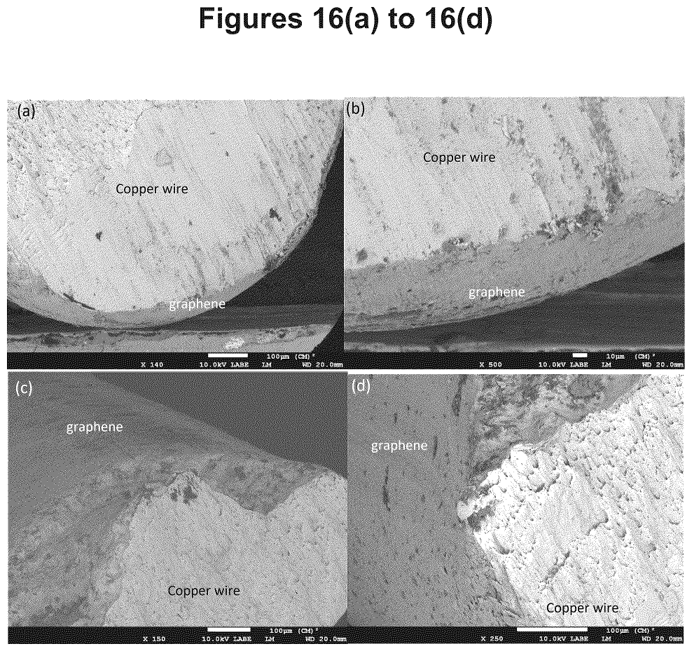

FIGS. 16(a) to 16(d) present the SEM images using secondary electrons mode on the surface and cross section of coper wire coated with in-situ grown graphene, sample G-CW-1. The bright area represents the core of the copper wire showing that the process does not damage the copper wire. The darker area shows the in-situ grown graphene on the surface of the copper wire. The results suggest that single layer (in grey) and few layers graphene (black patches) were produced by our technique.

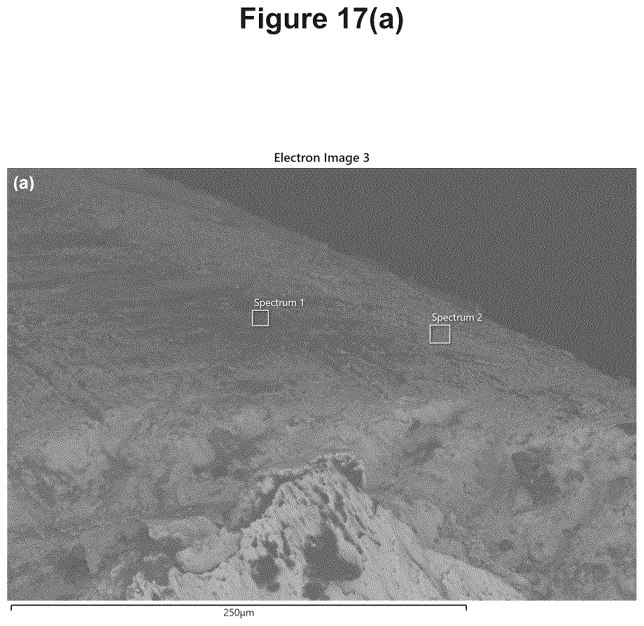

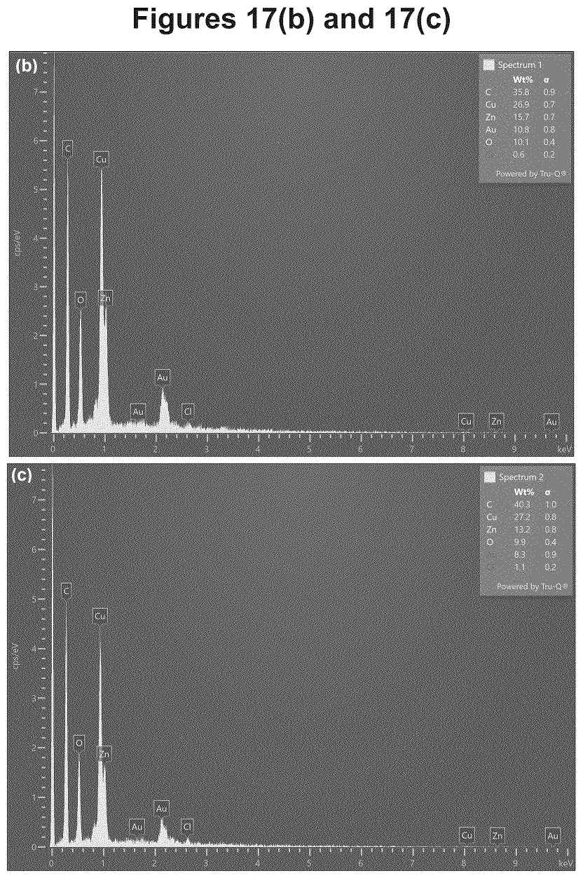

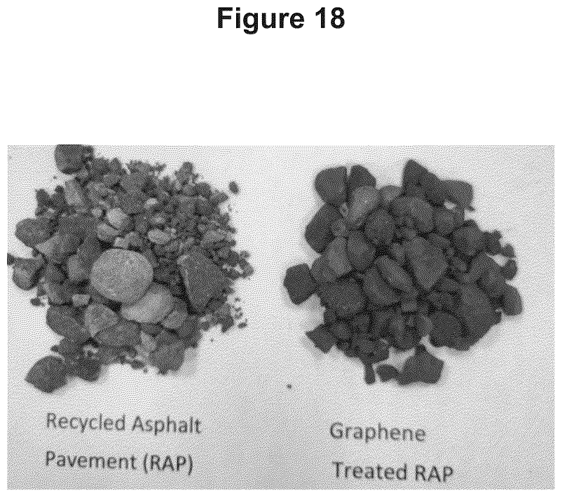

FIGS. 17(a) to 17(c) show the electron diffraction results (EDS) of copper wire coated with in situ grown graphene (sample G-CW-1). The spectra in (b) and (c) obtained demonstrate that the grey area is carbon on the surface of the copper. The gold, zinc and chlorine are signal of the sample holder.

### (v) Characterization of Graphene on Basalt Fibers (G-BF-1):

Sample G-BF-1, containing graphene gown on basalt fibers prepared as in Example 2, was also characterized by OM and SEM.

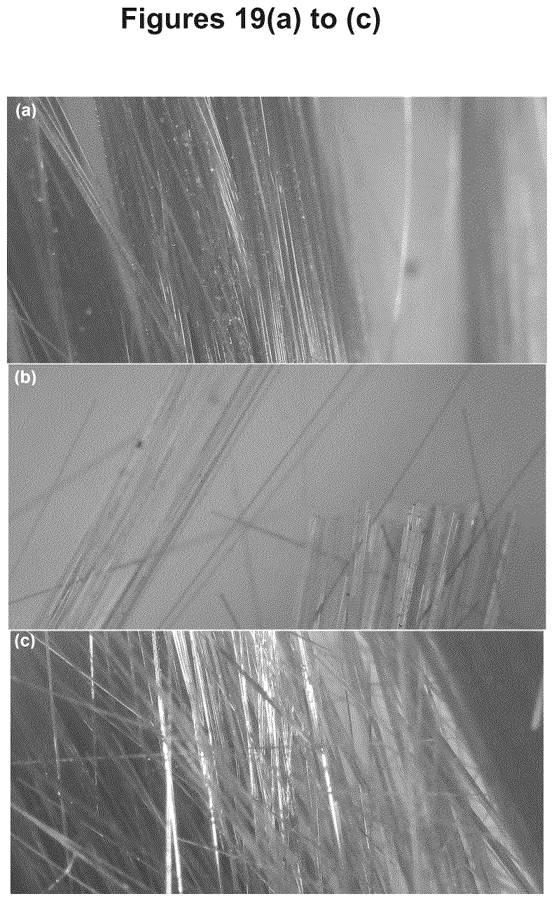

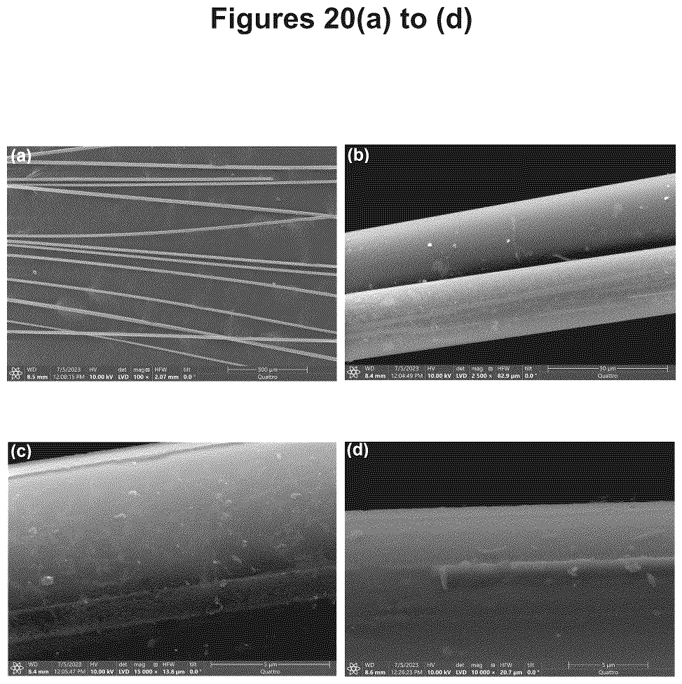

FIGS. 19(a) to 19(c) show optical microscope images of sample G-BF-1 while FIGS. 20(a) to 20(d) show SEM images obtained at (a) ×100, (b) ×2500, (c) ×15,000, and (d) ×10,000, of the surface of basalt fibers from sample G-BF-1 prepared in Example 2. These images show the presence of graphene formed on the surface of the fibers.

### (vi) Characterization of Graphene on Glass Beads (G-GB-1):

Sample G-GB-1, containing graphene gown on glass beads prepared as in Example 2, was characterized by OM and SEM.

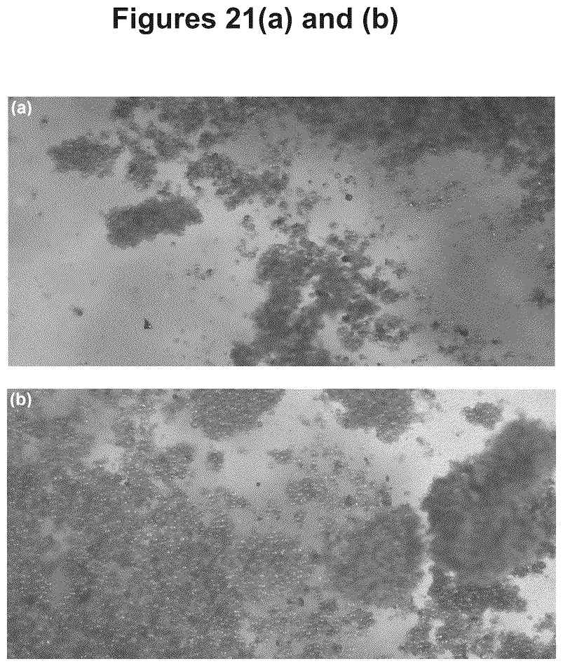

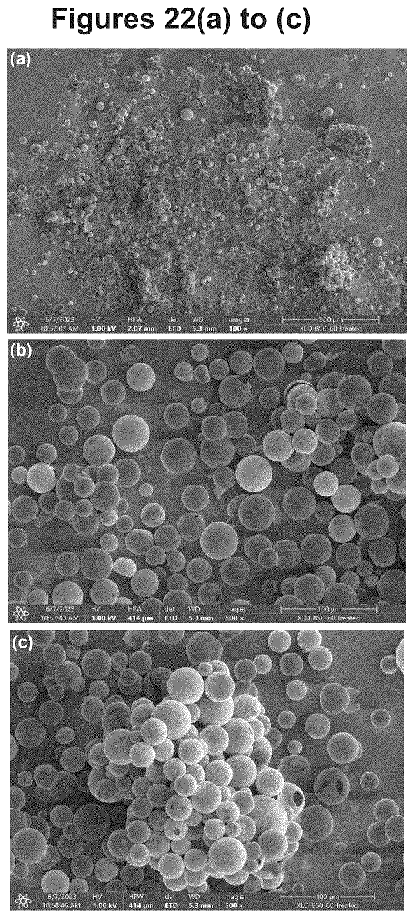

FIGS. 21(a) and 21(b) show optical microscope images of sample G-GB-1 prepared as in Example 2. FIGS. 22(a) to 22(c) show SEM images obtained at (a) ×100, (b) ×500, and (c) ×500, of the surface of glass beads from sample G-GB-1 prepared in Example 2. These images show the presence of graphene formed in situ on the surface of the glass beads, which are clearly visible for instance, in the SEM images.

(vii) Characterization of Graphene on Recycled Glass (G-RG-1):

Sample G-RG-1, containing graphene gown on recycled glass prepared as in Example 2, was also characterized by OM and SEM.

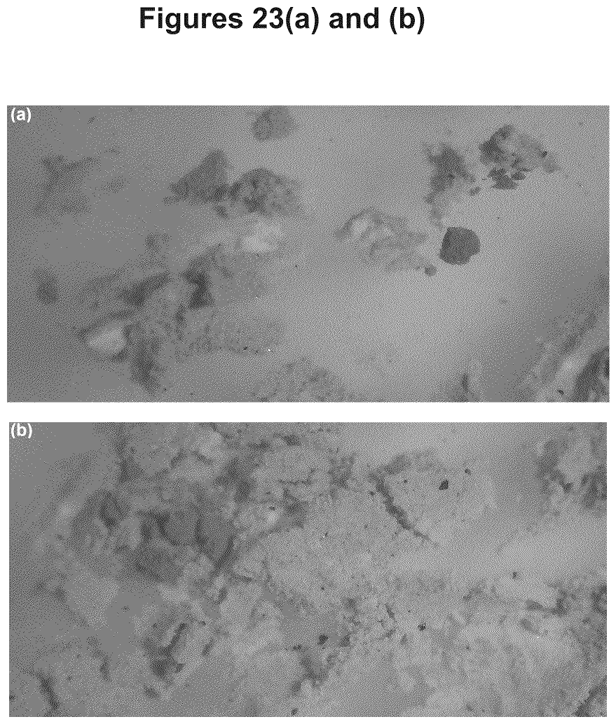

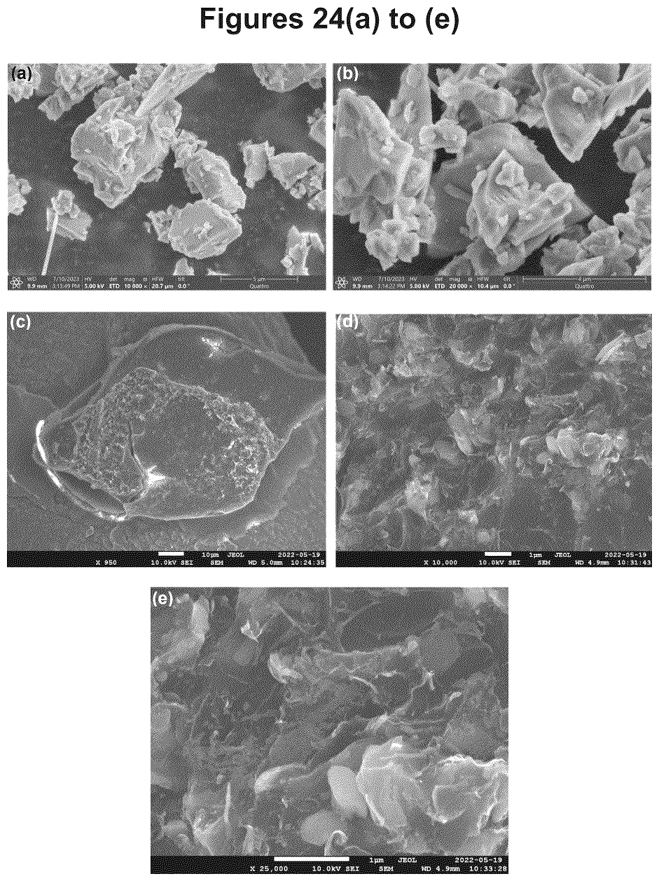

FIGS. 23(a) and 23(b) show optical microscope images while FIGS. 24(a) to 24(e) show SEM images obtained at (a) ×10,000, (b) ×20,000, (c) ×950, (d) ×10,000, and (e) ×25,000 of the recycled glass from sample G-RG-1 prepared in Example 2. These images show the presence of graphene formed in situ on the particles of recycled glass.

Numerous modifications could be made to any of the embodiments described above without departing from the scope of the present invention. Any references, patents or scientific literature documents referred to in the present document are incorporated herein by reference in their entirety for all purposes.

1. Process for the preparation of a material comprising graphene and/or graphite on a matrix, said process being selected from:
process A, comprising the steps of:
contacting a carbon-containing material, and optionally a catalyst, with a matrix; and
thermally treating at a temperature above 550° C. to induce graphitization and produce a graphitized carbon;
wherein said thermal treatment step comprises in situ generation of hydrogen (H₂);
wherein said process is carried out in the presence of restricted air and excludes injection of additional hydrogen or inert gas;
wherein said matrix is a material that does not react or decompose when exposed to the thermal treatment conditions; and
wherein said process does not include a chemical pre-treatment of the carbon-containing material and/or chemical post-treatment of the obtained graphene and/or graphite; and
process B, comprising the steps of:
(a) preparing a solution containing a carbohydrate source as a carbon-containing material, and optionally a catalyst, in a solvent (such as an aqueous solvent, e.g. water):
(b) contacting the solution from (a) with a matrix to obtain a mixture or coating on the matrix;
(c) optionally drying the mixture or coating at a temperature of at least 100° C.; and
(d) thermally treating at a temperature above 550° C. to induce graphitization and produce a graphitized carbon:
wherein said thermal treatment step (d) comprises in situ generation of hydrogen (H₂):
wherein said process is carried out in the presence of restricted air and excludes injection of additional hydrogen or inert gas:
wherein said matrix is a material that does not react or decompose when exposed to the conditions of the process; and
wherein said process does not include a chemical pre-treatment of the carbohydrate source and/or chemical post-treatment of the obtained graphene and/or graphite.

2. The process of claim 1, wherein in process A, said contacting step comprises spraying, soaking, or mixing, the carbon-containing material on or with the matrix, wherein the carbon-containing material is optionally melted or dissolved to form a solution prior to spraying, soaking or mixing, and/or said carbon-containing material is selected from carbohydrate sources, for instance from biomass, organic oils, petroleum-based oils, waxes, alcohols, resins, gums, or a combination of two or more thereof.

3. (canceled)

4. (canceled)

5. The process of claim 1, wherein in process B, said carbohydrate source comprises a monosaccharide, disaccharide, oligosaccharide or polysaccharide, or a mixture of two or more thereof, or said carbohydrate source comprises a monosaccharide or disaccharide, or a mixture thereof, or said carbohydrate source comprises an oligosaccharide or polysaccharide, or a mixture thereof, preferably said carbohydrate source being selected from fruit peels and processing refuse (e.g. orange peel, pulp, etc.), cereal husks (e.g. rice husks), wood waste, bagasse, wastepaper, recycled cotton fabric, biochar, nut shells, and the like.

6. (canceled)

7. (canceled)

8. (canceled)

9. The process of claim 1, wherein said contacting step of step (b) of process B comprises mixing, soaking or spraying the matrix with the solution.

10. The process of claim 1, wherein said step (c) of process B is present and carried out at a temperature within the range of about 150° C. to about 300° C., preferably about 200° C. to about 300° C., more preferably about 200° C. to about 250° C., and/or step (c) further comprises breaking di-, oligo- and/or polysaccharide chains, the di-, oligo- and/or polysaccharide chains being from the carbohydrate source.

11. (canceled)

12. The process of claim 1, wherein said matrix comprises at least one of sand, quartz, silica, gravel, granite, basalt, cement, concrete, asphalt, calcium carbonate, glass (e.g. powder, beads, fibers, etc.), metal and metal alloy surfaces (e.g. rods, grids, fibers, rebar, etc.), metal and metal alloy powders (e.g. nanoparticles, microparticles, etc.), metal oxides (e.g. TiO₂, Al₂O₃, etc.), ceramics such as zeolites (e.g. sodium aluminosilicate zeolites), inorganic dyes, nanomaterials, boron nitrate (e.g. nanotubes or nanosheets), metal chalcogenides (e.g. transition metal dichalcogenides (TMDC)), or a combination of at least two thereof.

13. The process of claim 1, wherein step (a) of process B or the contacting step of process A comprises the catalyst, preferably said catalyst being selected from FeCl₃, metal or metal alloys (e.g. Cu, Ge, Ni) particles or powders, metal oxides, or a combination thereof.

14. (canceled)

15. The process of claim 1, wherein said thermal treatment step is carried out at a temperature within the range of about 550° C. to about 1400° C., preferably within the range of about 700° C. to about 1200° C., more preferably within the range of about 800° C. to about 1100° C., or preferably within the range of about 550° C. to about 1000° C., or about 550° C. to about 900° C.; and/or said thermal treatment step is carried out in a covered vessel wherein said covered vessel is not sealed or wherein said covered vessel is sealed and includes pressure release valves or pressure control means, preferably the covered vessel is not sealed, preferably said covered vessel not being sealed.

16. (canceled)

17. (canceled)

18. (canceled)

19. (canceled)

20. (canceled)

21. The process of claim 1, wherein said process further comprises an intermediate thermal treatment carried out at a temperature within the range of about 400° C. to about 700° C. before the thermal treatment of process A or after step (d) of process B, preferably within the range of about 500° C. to about 650° C., more preferably within the range of about 500° C. to about 600° C.

22. (canceled)

23. (canceled)

24. The process of claim 1, wherein said process further comprises a step (e) after the thermal treatment of process A or after step (d) of process B, said step (e) comprising thermally treating the material of step (d) at a temperature within the range of about 200° C. to about 600° C. in the presence of air to eliminate residual amorphous carbon, preferably step (e) being carried out at a temperature within the range of about 200° C. to about 350° C.

25. (canceled)

26. The process of claim 1, wherein said process further comprises a mechanical treatment (e.g. grinding, milling, etc.) after the thermal treatment of process A or after step (d) of process B.

27. The process of claim 24, wherein said process further comprises a mechanical treatment (e.g. grinding, milling, etc.) after step (e).

28. The process of claim 1, wherein said content of residual amorphous carbon in the graphitized carbon is less than 5 wt. %, or less than 2 wt. %, or less than 1 wt. %, or preferably less than 0.5 wt. %, after the thermal treatment of claim 1 or after step (d) of claim 4.

29. The process of claim 1, wherein said process comprises a carbon conversion from the carbon-containing material to graphene and/or graphite of at least 30 mol %, at least 40 mol %, or at least 50 mol %.

30. The process of claim 1, wherein the material comprises graphene and said graphene has an average particle size or flake length between about 0.1 nm and about 5 mm, or between about 20 nm and about 1 mm, or between about 40 nm and about 500 m; and/or wherein the material comprises graphene and said graphene comprises monolayer graphene, few-layer graphene having from 2 to 20 layers, or a combination thereof.

31. The process of claim 1, wherein the material comprises graphene and said graphene has a structure comprising nanoflakes, nanoplatelets, carbon shells, or a combination thereof, preferably comprising nanoflakes or nanoplatelets, and/or a structure comprising nanocones, nanohorns, nanodandelions, nanoribbons, nanopetals, or a combination thereof.

32. (canceled)

33. The process of claim 1, wherein the material comprises graphite and said graphite is synthetic graphite having a structure comprising synthetic graphite platelets or nanoplatelets.

34. (canceled)

35. The process of claim 1, wherein the material comprises graphene and said graphene and/or graphite has a carbon content of at least 80 mol %, at least 90 mol %, at least 95 mol %, or at least 97 mol %, or at least 98 mol %, or at least 99 mol %.

36. Material prepared by a process as defined in claim 1.

37. Material comprising graphene and/or graphite supported on a matrix, said graphene and/or graphite comprising a carbon content of at least 95 mol %, or at least 97 mol %, or at least 98 mol %, or at least 99 mol %, wherein:
said matrix comprises at least one of sand, quartz, silica, gravel, granite, cement, calcium carbonate, glass fibers, metal and metal alloy surfaces (e.g. rods, grids, fibers, rebar, etc.), metal and metal alloy powders (e.g. nanoparticles, microparticles, etc.), metal oxides (e.g. TiO₂, Al₂O₃, etc.), ceramics such as zeolites (e.g. sodium aluminosilicate zeolites), inorganic dyes, nanomaterials, boron nitrate (e.g. nanotubes or nanosheets), metal chalcogenides (e.g. transition metal dichalcogenides (TMDC)) or any other material that can withstand the above process conditions; and/or
said graphene has a structure comprising nanoflakes, nanoplatelets, carbon shells, or a combination thereof, preferably comprising nanoflakes or nanoplatelets, and/or a structure comprising nanocones, nanohorns, nanodandelions, nanoribbons, nanopetals, or a combination thereof; and/or
said graphite is synthetic graphite having a structure comprising synthetic graphite platelets or nanoplatelets; and/or
said graphene has an average particle size or flake length between about 0.1 nm and about 5 mm, or between about 20 nm and about 1 mm, or between about 40 and about 500 m; and/or
said graphene comprises monolayer graphene, few-layer graphene (2 to 20 layers), or a combination thereof.

38. (canceled)

39. (canceled)

40. (canceled)

41. (canceled)

42. (canceled)

43. (canceled)
